(19) United States
(12) Patent Application Publication
(10) Pub. No.: US 2024/0414558 A1
(43) Pub. Date: Dec. 12, 2024

(54) OPERATING A WIRELESS COMMUNICATION NETWORK USING A DIGITAL TWIN

(71) Applicant: Fraunhofer-Gesellschaft zur Förderung der angewandten Forschung e.V., München (DE)

(72) Inventors: Thomas HAUSTEIN, Berlin (DE); Paul Simon Holt LEATHER, Berlin-Schlachtensee (DE)

(21) Appl. No.: 18/654,966

(22) Filed: May 3, 2024

Related U.S. Application Data
(63) Continuation of application No. PCT/EP2021/080844, filed on Nov. 5, 2021.

(51) Int. Cl. H04W 16/22; H04W 16/28

(52) U.S. Cl. CPC H04W 16/22; H04W 16/28

(57) ABSTRACT

A method for operating a wireless communication network including at least two network nodes including a wireless interface each and adapted for a wireless communication, the at least two network nodes including a plurality of network entities comprises using a digital twin, DT, of a network entity of the plurality of network entities to derive a behaviour of the network entity, the behaviour being based on a stimulus to the network entity; or comprises using the DT of the network entity to derive a stimulus to the network entity resulting in a predefined targeted behaviour of the network entity.

### CROSS-REFERENCE TO RELATED APPLICATION

This application is a continuation of copending International Application No. PCT/EP2021/080844, filed Nov. 5, 2021, which is incorporated herein by reference in its entirety.

The present invention relates to a method for operating a wireless communication network and to an apparatus and a wireless communication network for implementing such a method. The present invention further relates to a wireless communication system digital twin and its application.

### BACKGROUND OF THE INVENTION

A radio access network (RAN) is a system that connects individual devices to other parts of a network through radio connections. Open RAN refers to the overall concept of creating the possibility of an open RAN environment, with interoperability between different vendors happening over a set of defined interfaces.

The rapid deployment of 5G networks requires an evolution of today's mobile broadband services, using lower unit costs and improved end-user performance, and to address new business segments using 5G and beyond 5G system capabilities. To achieve this, operators are designing network architectures that will scale to device and traffic densities far beyond what is commonplace in the 4G LTE networks today and meet the latency and reliability requirements of demanding new service types. This is critical preparation for the 5G super-cycle that will enable operators to extend their reach into diverse markets over the next ten years.

An essential part of the new design is the transport network that provides connectivity between radio sites, edge data centres and cloud applications. Because 5G NR will be introduced into large, well-optimized and commercially productive 4G LTE networks, integration into existing environments is important, therefore an integrated 4G/5G transport is important as well. 5G RAN transport and connectivity are more than necessary costs for operators; they are an investment in critical assets that will generate unique advantages in the way customers experience and interact with services. It is an architecture for the long-term development of the 5G service offer that requires inter-vendor operability requiring on the one hand both 3GPP and IEEE standardization and on the other, open specifications. The evolution of such an Open RAN architecture is not possible without the means to exchange complex technical information between the equipment provided by multiple vendors. This is true not only for equipment that contains actively-powered electronic circuits (e.g. base station units and active antenna system (AAS) units) but also for passive units such as a traditional base station antenna.

### SUMMARY

An embodiment may have a method for operating a wireless communication network comprising at least two network nodes comprising a wireless interface each and adapted for wireless communication; wherein the method comprises: using a digital twin, DT, of a network entity of the plurality of network entities to derive a behaviour of the network entity, the behaviour being based on a stimulus to the network entity; or using the DT of the network entity to derive a stimulus to the network entity resulting in a targeted behaviour of the network entity.

Another embodiment may have a method comprising: using a device by a user; measuring a behaviour of the device during a first instance of time when the device is used by the user to acquire a measurement result; using a digital twin, DT, of at least a part of the device and using the measurement result to generate a DT of the user; and using the DT of the user for evaluating a behaviour of the device during a second, later instance of time.

Another embodiment may have a non-transitory digital storage medium having a computer program stored thereon to perform the method for operating a wireless communication network comprising at least two network nodes comprising a wireless interface each and adapted for wireless communication; wherein the method comprises: using a digital twin, DT, of a network entity of the plurality of network entities to derive a behaviour of the network entity, the behaviour being based on a stimulus to the network entity; or using the DT of the network entity to derive a stimulus to the network entity resulting in a targeted behaviour of the network entity, when said computer program is run by a computer.

Another embodiment may have a non-transitory digital storage medium having a computer program stored thereon to perform the method comprising: using a device by a user; measuring a behaviour of the device during a first instance of time when the device is used by the user to acquire a measurement result; using a digital twin, DT, of at least a part of the device and using the measurement result to generate a DT of the user; and using the DT of the user for evaluating a behaviour of the device during a second, later instance of time, when said computer program is run by a computer.

Another embodiment may have an apparatus, e.g., a network entity, a controller or network node being configured for implementing a method for operating a wireless communication network comprising at least two network nodes comprising a wireless interface each and adapted for wireless communication; wherein the method comprises: using a digital twin, DT, of a network entity of the plurality of network entities to derive a behaviour of the network entity, the behaviour being based on a stimulus to the network entity; or using the DT of the network entity to derive a stimulus to the network entity resulting in a targeted behaviour of the network entity.

Another embodiment may have an apparatus, e.g., a network entity, a controller or network node being configured for implementing a method comprising: using a device by a user; measuring a behaviour of the device during a first instance of time when the device is used by the user to acquire a measurement result; using a digital twin, DT, of at least a part of the device and using the measurement result to generate a DT of the user; and using the DT of the user for evaluating a behaviour of the device during a second, later instance of time.

Another embodiment may have a wireless communication network being configured for implementing a method for operating a wireless communication network comprising at least two network nodes comprising a wireless interface each and adapted for wireless communication; wherein the method comprises: using a digital twin, DT, of a network entity of the plurality of network entities to derive a behaviour of the network entity, the behaviour being based on a stimulus to the network entity; or using the DT of the network entity to derive a stimulus to the network entity resulting in a targeted behaviour of the network entity.

Another embodiment may have a wireless communication network being configured for implementing a method comprising: using a device by a user; measuring a behaviour of the device during a first instance of time when the device is used by the user to acquire a measurement result; using a digital twin, DT, of at least a part of the device and using the measurement result to generate a DT of the user; and using the DT of the user for evaluating a behaviour of the device during a second, later instance of time.

According to an embodiment, a method for operating a wireless communication network comprises at least two network nodes comprising a wireless interface each and adapted for a wireless communication, the at least two network nodes comprising a plurality of network entities comprises using a digital twin, DT, of a network entity of the plurality of network entities to derive a behaviour of the network entity, the behaviour being based on a stimulus to the network entity. The method alternatively or in addition comprises using the DT of the network entity to derive a stimulus to the network entity resulting in a behaviour of the network entity. Via the digital twin it is possible to exchange the information of the modelled device or entity regardless whether the digital twin is externally provided or self-generated.

According to an embodiment a method comprises using a device by a user, i.e., a user uses the device. The method further comprises measuring a behaviour of the device during a first instance of time when the device is used by the user to obtain a measurement result. The method comprises using a digital twin, DT, of at least a part of the device and using the measurement result to generate a DT of the user. The method further comprises using the DT of the user for evaluating a behaviour of the device during a second, later instance of time. Such a method allows to obtain detailed information about an interaction between a user and a device which allows to exchange the required information of the device on the one hand and to properly control the device on the other hand when being used by a user as a user may affect the operation of the device, e.g., when regarding a propagation of the radio waves.

Further embodiments relate to wireless communication networks and devices for implementing methods described herein.

### BRIEF DESCRIPTION OF THE DRAWINGS

Embodiments of the present invention will be detailed subsequently referring to the appended drawings, in which:

FIG. 1 shows a schematic flowchart of a method according to an embodiment;

FIG. 2a shows a schematic block diagram of a network entity in accordance with embodiments;

FIG. 2b shows a schematic block diagram of a digital twin in accordance with embodiments being operated, for example, on a calculating unit such as a computer or processing unit;

FIG. 3 showing at least a part of a wireless communication network in accordance with an embodiment;

FIG. 4 shows a schematic block diagram of a network node according to an embodiment;

FIG. 5 shows a schematic flowchart of a method that may form a part of method of FIG. 1 in accordance with an embodiment;

FIG. 6 shows an example of a generic analogue beamformer that may form a network entity in accordance with an embodiment;

FIG. 7 shows a schematic diagram of a digital beamforming that may form a network entity in accordance with an embodiment;

FIG. 8 shows a fully-connected scheme with phase shifters that may form a network entity in accordance with an embodiment;

FIG. 9 shows a schematic block diagram representing a multiple RF chains that may form a network entity in accordance with an embodiment;

FIG. 10 shows a simplified and generalized representation of both the fully-connected and partially-connected hybrid beamforming systems according to an embodiment;

FIG. 11 shows a schematic block diagram representing a second hybrid beamforming architecture according to an embodiment;

FIG. 12a shows a functional block diagram showing the arrangement and connection of a radio unit (RU), a distributed unit (DU), a centralized unit (CU) and a core according to an embodiment;

FIG. 12b shows an extension of FIG. 12a by a reconfigurable intelligent surface, RIS, according to an embodiment;

FIG. 12c shows a schematic block diagram of multiple controllers controlling an entity using a DT in connection with the concept of hierarchy according to an embodiment;

FIG. 13-15 show three examples of how a third-party controller can be integrated into a wireless communication system according to an embodiment;

FIG. 16 shows a schematic representation of signals that are to be transmitted to a network entity according to an embodiment;

FIG. 17 shows a functional diagram showing interfaces between the core network, a distributed unit, a radio unit together with an antenna unit, several user equipment devices and a third-party controller according to an embodiment;

FIG. 18a-b show schematic block diagrams of a real and virtual test system according to an embodiment;

FIG. 19 shows an example a radio unit (RU) comprised of various functional blocks according to an embodiment;

FIG. 20 shows a schematic block diagram of a DU according to an embodiment;

FIG. 21 shows a block diagram of a CU according to an embodiment;

FIG. 22 shows an example of a core unit (CORE) according to an embodiment;

FIG. 23 shows a functional block diagram showing the arrangement and connection of radio unit (RU), distributed unit (DU), centralized unit (CU) and core using fronthaul, midhaul and backhaul interfaces according to an embodiment;

FIG. 24 shows a schematic illustration of different network configurations in accordance with embodiments;

FIG. 25a-c show a schematic representation of a traditional RAN, 5G Virtual RAN (VRAN) and Open RAN (ORAN) architectures according to embodiments;

FIG. 26 shows an example of commercial deployment examples of Open RAN and Virtual RAN architectures according to an embodiment;

FIG. 27 shows an example of a platform independence of Java for explaining embodiments;

FIG. 28a-c show different antenna units connected to radio units according to embodiments;

FIG. 29 shows a schematic flowchart of a method according to an embodiment relating to modelling a user of a device;

FIG. 30 shows a schematic representation of a partitioning of a network node according to an embodiment; and

FIG. 31 shows a schematic representation of a network scenario in which reconfigurable intelligent surfaces (RISs) form at least parts of network entities according to an embodiment.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to a digital twin, DT. As a digital twin a person skilled in the art may understand a virtual representation that serves as the digital counterpart of a physical object or process.

The DT may comprise a digital data representing at least one of a functionality, a physical characteristic, an embedded function, a feature such as a distinctive attribute or aspect of a part of the entity and/or a service of the network entity.

A digital twin may, but is not required to be a real-time representation of the object. A digital twin of a physical object may be based on a data-driven architecture to link information of the device or a part thereof, components of such an entity and possibly information about an environment of the device that interacts with the device. That is, a change in the entity for which a digital twin, DT is present may lead to a change in the DT. A DT may, however, be subject for singulations and/or virtual experiments and provide for a result or stimulated behaviour to obtain knowledge about the behaviour of the device to be expected without subjecting the device to a real or physical stimulus.

A DT as described herein may be a real-time representation of the entity to be regarded or not. That is, the DT may also relate to an offline model of the entity and/or may be stored on a data carrier. In general, the digital twin may be understood as a virtual copy of the real entity.

Embodiments described herein relate to a behaviour of a network entity. As a behaviour it may be understood a reaction or output of the network entity to be obtained responsive or based on a stimulus or a set of stimuli acting on the network entity. The behaviour may relate, among others, to a beam pattern formed with a wireless interface of a network node comprising the network entity. For example, a method described herein may comprise to examine a beam correspondence executed by the network entity, e.g., as stimulus and/or behaviour. For example, with regard to a network entity having a wireless antenna interface, a stimulus may be a detected orientation of the network entity. This stimulus may lead to a reaction of the network entity to point a radio beam pattern formed with the antenna array towards a specific direction, e.g., a base station. A change in a relative position, e.g., another stimulus, may lead to a reaction, i.e., a behaviour, that the device changes the relative orientation of the beam so as to maintain an absolute direction of the beam towards the base station. A stimulus may be understood as any physical or virtual input to the device, e.g., a physical parameter such as temperature, orientation, size, movement or the like or information such as commands, instructions, measurement data or the like. A behaviour may be considered as a reaction of the device being based on the stimulus or multiple stimuli.

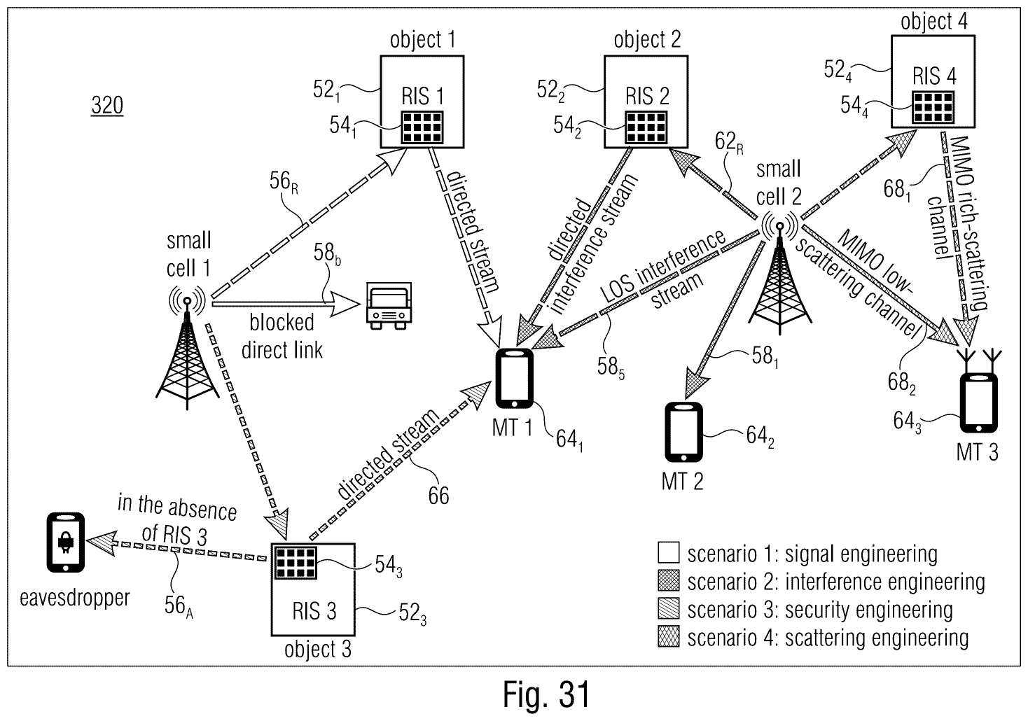

Embodiments described herein relate to network nodes having one or more network entities. As a network node, one may understand a device such as a user equipment, a base station, an IAB node, a baseband unit, a gNB, a radio unit, RU, a distributed unit, DU, a central unit, CU, a core entity, a controller, a processing unit or the like. Such devices may comprise more than just one single network entity comprising, for example, a radio unit or antenna array, another network entity comprising, for example, a processing unit and another entity comprising, for example, a baseband unit. Such a connection of single network entities may form a network node or at least a part thereof. However, network entities described herein may but are not necessarily required to be part of a network node. For example, a so-called reconfigurable intelligent surface, RIS, being part of the scenario of FIG. 31 may also be part of a wireless communication network although not necessarily providing for an active communication. Nevertheless, such a structure may also be modelled by a DT and show a behaviour responsive to a stimulus. A RIS may reflect, for example, a wireless signal between a first network node and a second network node and may form at least a part of a network entity that is different from the first node and the second node but nevertheless part of the wireless communication network. While a RIS may thus be considered as a network entity, perhaps a RIS controller (e.g., a function or apparatus that controls the RIS) may be considered as a network node as it may form a part of the communication.

Embodiments described herein relate to modelling such a network entity with a digital twin. A digital twin may, however, also relate to a set of network entities, e.g., a combination of a radio unit and a baseband unit or the like.

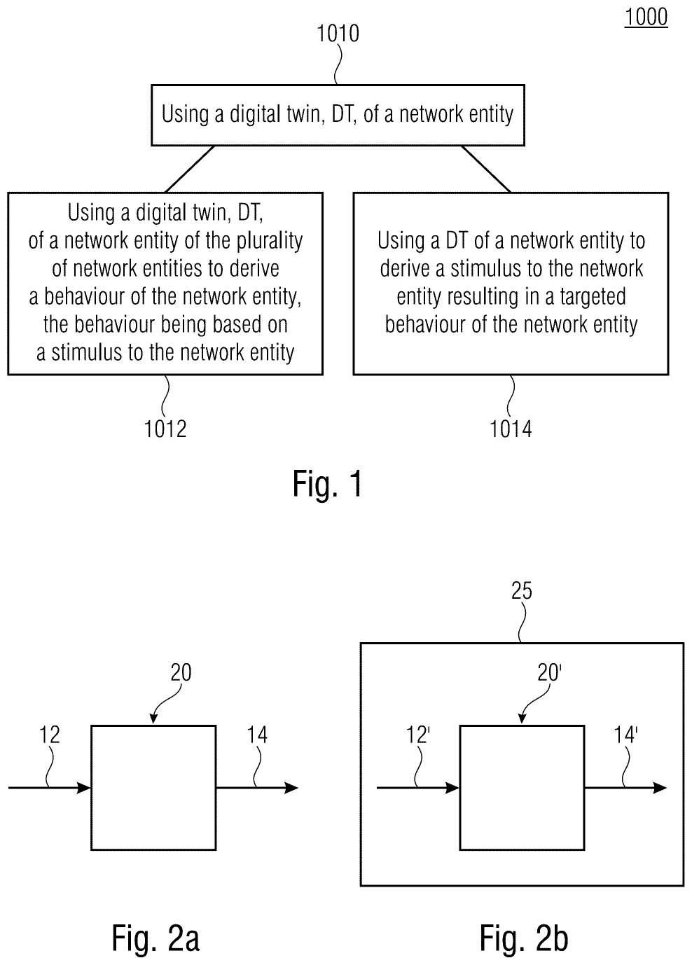

FIG. 1 shows a schematic flowchart of a method 1000 according to an embodiment. A step 1010 comprises using a digital twin, DT, of a network entity. Step 1010 may be implemented, for example, as implementation 1012 to use the DT of the network entity of a plurality of network entities to derive a behaviour of the network entity, the behaviour being based on a stimulus to the network entity. Alternatively or in addition, step 1010 may be subject of implementation 1014 to use the DT of a network entity to derive a stimulus to the network entity resulting in a targeted behaviour of the network entity.

Method 1000 is further explained in connection with FIG. 2a showing a schematic block diagram of a network entity 20 in accordance with embodiments. Network entity 20 may form at least a part or component of a network node to be operated in a wireless communication network or system described herein. Responsive to a stimulus 12, the network entity 20 may show a behaviour 14. That is, the network entity 20 may react on the stimulus 12. Stimulus 12 may comprise any sort of information, change in a physical property or parameter, data, instruction or the like. Behaviour 14 may, correspondingly, relate to any action performable with the network entity 20, i.e., activating or deactivating a component, an interface, an actuator, a data channel or the like, providing or manipulating information or even doing nothing.

Both, the stimulus 12 and the behaviour 14 may independently from one another relate to a set of stimuli, behaviour, respectively. That is, a single stimulus may lead to one or more resulting actions as a behaviour and/or one or more stimuli 12 may lead to one or more actions as a behaviour.

When referring to an implementation or a step 1012, using the digital twin to derive a behaviour may relate to having the knowledge about the stimulus and to determine the behaviour 14 to be expected.

FIG. 2b shows a schematic block diagram of a digital twin 20′ being operated, for example, on a calculating unit such as a computer or processing unit. However, a digital twin 20′ may also be stored on a data carrier for a later use. A calculation unit 25 running, maintaining or operating digital twin 20′ may have knowledge about a digital representation 12′ of stimulus 12 and/or about a digital representation 14′ of the behaviour 14 of the real or physical network entity 20. When implementing the implementation 1012, using the digital twin 20′ may allow to derive the behaviour 14 as the digital representation 14′ thereof when using the digital representation 12′ of the stimulus. For example, when having knowledge about the stimulus 12, the digital representation 12′ thereof may be formulated for the calculation unit 25. However, the digital representation 12′ may not necessarily require a real or physical basis but may also be subject of virtual generation or stimulation. That is, a real or virtual scenario may be transferred to responsive stimuli 12′ so as to examine a behaviour 14′ to be expected. This allows for multiple advantages when operating wireless communication networks. First, it may be examined what the responsive network entity 20 is expected to do when receiving the stimulus 12. This may form a basis, for example, for decisions whether to use or avoid a respective stimulus 12. Alternatively or in addition, a verification may be based on an examination if the network entity 20 represented as its digital twin 20′ provides for the expected behaviour.

Alternatively or in addition, when implementing method 1000 by implementation 1014 to use the digital twin 20′ of the network entity 20 to derive a stimulus to the network entity resulting in a targeted behaviour of the network entity 20, a set of different behaviours 14′ may be examined to select one of them as a targeted behaviour. Staring therefrom, it may be examined which stimulus 12′ (or set of stimuli) will lead to this targeted behaviour. This allows to stimulate the network entity 20 in a desired way to obtain the targeted behaviour 14, possibly without causing unwanted behaviour at the real entity 20, performing a trial and error test at the real entity. Optionally, the digital twin 20′ may be transferred to an inverse model that receives the targeted behaviour as an input and outputs one or more stimuli or sets of stimuli that will cause the targeted behaviour.

For example, implementation or step 1012 may allow to derive the behaviour of the network entity, the behaviour being based on a stimulus to the network entity. The method may be operated such that the digital twin models represent the network entity being a first network entity. The calculation unit 25 may be hard or accessible to a second network entity such that the second network entity uses the DT 20′ to determine information indicating the behaviour 14 of the entity 20. Such a method may comprise to use the information indicating the behaviour of the first entity, e.g., to adapt the behaviour of the second, modelled entity knowing what the entity 20 will do and/or to command the entity 20 to implement a specific behaviour. Alternatively or in addition, the calculation unit 25 may be a part or accessible to network entity 20 such that the network entity or a device having this entity 20 models at least a part of itself. That is, the network entity may examine its own behaviour and the method may comprise using the information indicating the behaviour, e.g., to adapt the own behaviour. For example, a targeted behaviour of the network entity may be a specific direction of a beam to be formed or a specific point in the environment to be illuminated with a beam to be formed with the antenna unit. However, as a stimulus, the network entity may have knowledge about control signals or commands to be generated internally, e.g., on how to operate antenna elements or sets thereof. By using the digital twin 20′, the network entity may examine, e.g., before forming the real beam, which control signals will lead to the desired beam. This may allow to reduce efforts in the wireless communication network to have feedback operations indicating, to the network entity or network node, that the beam is formed correctly or incorrectly.

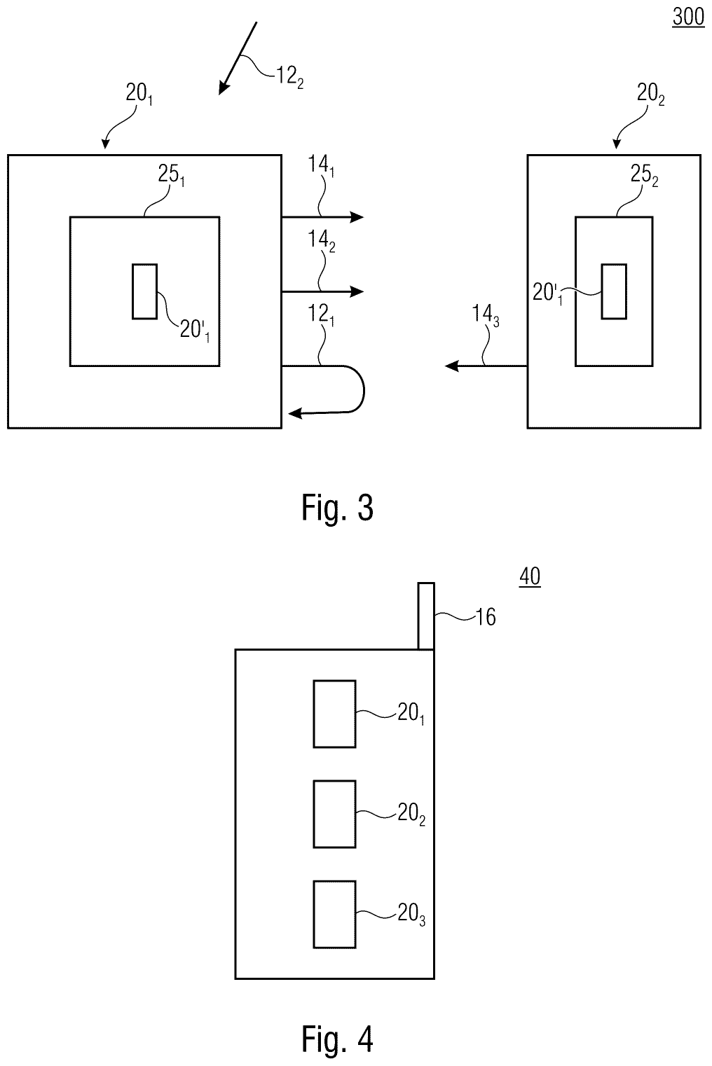

This is further explained in connection with FIG. 3 showing at least a part of a wireless communication network 300. FIG. 3 shows two network entities 20₁ and 20₂, each forming at least a part of a respective network node configured to perform a wireless communication in the wireless communication network 300, e.g., using an antenna interface thereof so as to perform a wireless communication.

Network entities 20₁ and 20₂ may be part of a same network node or of different network nodes. Network entities 20₁ and 20₂ may comprise a lowest granularity of functionality, e.g., when referring to the example of a radio unit, a single antenna element, a combination of antenna elements, a transmitter chain, a receiver chain, a transceiver chain or a combination thereof.

Network entity 20₁ may comprise a calculation unit 25₁ that runs or executes or maintains a digital twin 20′₁ of network entity 20₁. The network entity 20₁ may use its own digital twin to derive a stimulus 12₁ that leads to a targeted behaviour 14₁ of the network entity 20₁. Alternatively or in addition, the network entity 20₁ may recognize that it shows the behaviour 14₁, e.g., due to internal measurements or external reports or the like and may derive the stimulus 12₁ that causes the behaviour 14₁.

Alternatively or in addition, the network entity 20₂ may comprise a calculation unit 25₂ that also runs digital twin 20′₁. Similarly to the operation of digital twin 20′₁ at network entity 20₁, network entity 20₂ may determine a stimulus 12₂ that leads to a behaviour 14₂ of the network entity 20₁. The stimulus 12₂ may be generated partially or completely by a network node comprising the network entity 20₂, but may also be generated without its participation. That is, network entity 20₂ may obtain an understanding what has caused the network entity 20₁ to perform the behaviour 14₂ using the digital twin 20′₁. Alternatively, it may determine what will cause the network entity 20₁ to show the behaviour 14₂ as a targeted behaviour.

For example, the DT 20′₁ may model or represent network entity 20₁ and may be used by network entity 20₂ to determine information indicating the behaviour 14₂ and/or 14₁ as a targeted behaviour. Such a method may comprise using the information obtained such that using the information indicating the behaviour may comprise an adaptation of a behaviour of network entity 20₂ based on the targeted behaviour of the first entity to generate the stimulus 12₂ for network entity 20₁ for causing the network entity 20₁ to show the targeted behaviour 14₂. Such a method may optionally be executed that an adaptation of the behaviour relates to a transmission and/or a reception behaviour based on wanted or unwanted interference experienced by at least one of entities 20₁ and 20₂. For example, entity 20₂ may recognize entity 20′₁ that it shifts or otherwise adapts a transmission or reception beam. It may recognize that one or more entities experience interference and may adapt its own behaviour or may instruct the other entity 20₁ to adapt its behaviour to avoid interference.

Embodiments may also relate to a DT of a network entity to be used to derive a stimulus to the network entity resulting in the targeted behaviour the network entity, as described. Such a method may be implemented such that the DT 20′₁ models network entity 20′₁ and is used by network entity 20₂ to derive a command for instruction or message or other action for network entity 20₁ to form stimulus 12₂ to cause the targeted behaviour 14₂ of network entity 20₁. The method may comprise transmitting the command to the network entity 20₁, either directly from entity 20₂ or the network node comprising the network entity or indirectly, e.g., via transmitting a respective command to other nodes such as a part of an infrastructure or the like. Alternatively or in addition, the DT 20′₁ may model the network entity 20₁ and may be used by the network entity 20₁ to derive a command for the network entity 20₁ itself and as a stimulus to cause a targeted behaviour 14, of the network entity 20₁. The method may comprise executing the command with the network entity 20₁, the network node respectively.

According to embodiments, the stimulus to cause the targeted behaviour 14₂ may be determined as a stimulating behaviour to be shown by network entity 20₂ to act as a stimulus to network entity 20₁ to then cause behaviour 14₂. This is represented as behaviour 14_{S} shown by network entity 20₂. The behaviour 14_{S} may be determined by any network entity for a calculating unit that runs DT 20′₁. Optionally, this may include to also model network entity 20₂ by a respective DT so as to transfer, for example, stimulus 12₂ or a part thereof into the behaviour 14_{S}.

FIG. 4 shows a schematic block diagram of a network node 40 according to an embodiment that may be operated within a wireless communication network described herein. Network node 40 may comprise, for example, a wireless interface 16 configured for generating a beam pattern. This beam pattern may be omnidirectional but may refer to a beamforming technique and may be adapted over time.

Network node 40 may comprise a plurality of at least two or more network entities, e.g., network entities 20₁, 20₂ and 20₃, wherein any other number of at least two, at least three, at least four, at least five or at least ten network entities may be used. Alternatively, network node 40 may be represented as a single network entity. A network entity in accordance with the embodiments may comprise at least one of a radio unit, a distributed unit, DU, a centralized unit, CU, a base transceiver station (BTS) antenna, a user equipment (UE) antenna, an integrated access and backhaul (IAB) antenna and/or a combination thereof and/or additional entities. For example, network entities 20₁, 20₂ and 20₃ may refer to same or different types of entities, e.g., different radio units of a same base station. Alternatively, one of the network entities 20₁ may comprise a radio unit while another network entity comprises a baseband unit or the like. The network node 40 may be a real device but may also be some kind of virtual combination of devices, e.g., a combination of a DU and a RU.

The network node 40 may comprise at least one of a base station (BTS), an eNB (e.g., in 4G-LTE or a GNB (e.g., in 5G-NR), a user equipment, a repeater, a network controller, a reconfigurable intelligent surface (RIS) controller, an access node, a backhaul node, an integrated access and backhaul device, a terrestrial network, a non-terrestrial network, a part thereof and/or a combination thereof.

Based on its virtual or digital representation, the digital twin generated and/or used may refer to any combination of relevant functions to be modelled digitally to allow for an understanding and/or efficient control of a device or network entity. This is of particular advantage for so-called third party controllers. While a digital twin may allow to provide for an understanding and/or a source of control for such third party controllers while avoiding a full control or a provision of the complete code or operational instructions, it may be generated and/or provided in different degrees of service. For example, different DTs relating to the same network entity may allow for different levels of control, for example, based on a sort of basis version and professional version, different fees are to be paid for different network priorities.

Embodiments of the present invention may relate to a method in which the DT is static or dynamic. A static DT may be a proper solution for static systems or scenarios in which, for example, the network entity is static. Alternatively or in addition, a dynamic DT that is changed and/or updated over time may allow to consider changing conditions and/or scenarios. According to embodiments, a DT is updated. Such a method may comprise updating the DT based on measurements that measure the behaviour and/or a parameter influencing the behaviour, e.g., a stimulus or a part thereof. Updating may be executed at least once. However, updating may be executed more often and, e.g., in a scheduled way, responsive to a triggering event, periodically or dynamically. A triggering event may comprise, for example, a received command, an indication that a specific event has happened and/or a recognition about a change in the wireless communication network.

According to an embodiment, updating may comprise determining information indicating a behaviour and/or a stimulus leading to the behaviour and updating the DT based on the determined information. That is, for example, if a new behaviour and/or an unknown stimulus is recognized, its influence and/or its root cause may be determined and the DT may be updated correspondingly.

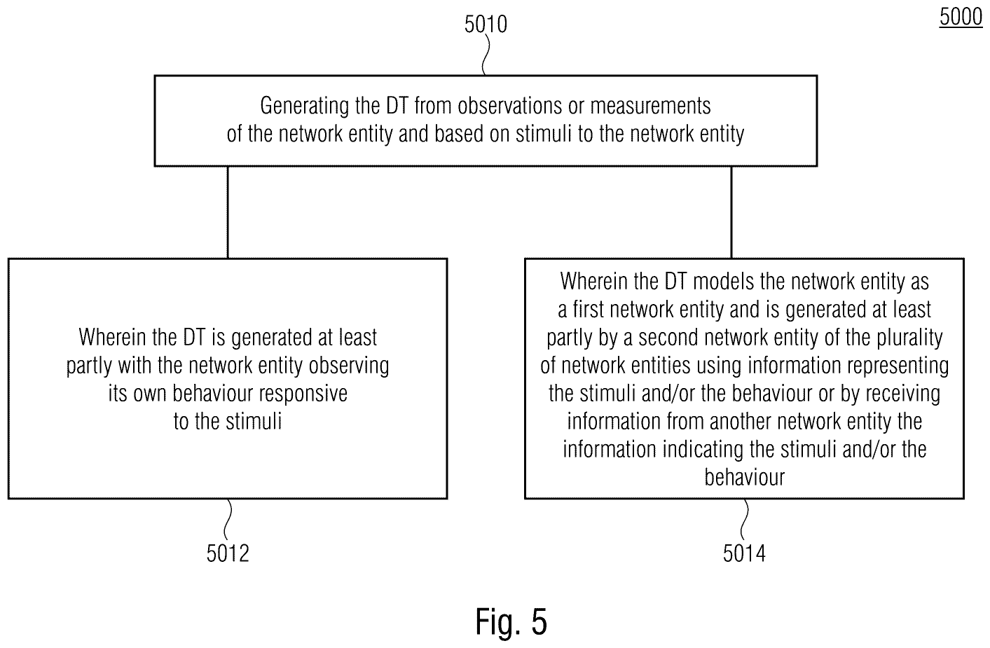

Besides an updating of a digital twin, embodiments also relate to generating the DT. FIG. 5 shows a schematic flowchart of a method 5000 that may form a part of method 1000 and/or may be executed separately. A step 5010 comprises generating the DT from observations or measurements of the network entity and based on stimuli to the network entity. That is, stimuli and the behaviour they cause may be measured. As illustrated for implementation 5012, the DT may be generated at least partly by the modelled network entity itself by observing its own behaviour responsive to the stimuli. Alternatively or in addition, the DT may be modelled by a device different from the modelled device as illustrated for implementation 5014. The DT may model the network entity that may be generated at least partly by a different network entity by using information representing the stimuli and/or the behaviour or by receiving information from another network entity, the information indicating the stimuli and/or the behaviour. That is, the generation of the digital twin representing a different entity may rely on own measurements, but may also rely on measurements provided by a different entity.

Each implementation 5012 and 5014 may allow to generate the DT. However, when generating at least a part of the DT, the results of implementation 5012 and 5014 may be combined to obtain a final DT.

The ability to generate or provide the DT at least in part during runtime by observing stimuli and/or a resulted behaviour also allows for validating or defining an existing DT that is provided, for example, by a manufacturer or a different entity and/or was generated earlier. Such a method may comprise, for example, having the DT as a generated DT and obtaining a provided DT of the network entity, e.g., provided by a manufacturer of the network entity. The method may comprise comparing the generated DT with the provided DT to obtain a comparison result. The method may comprise using and/or providing the comparison result. This may allow to detect the efficiencies in the provided DT and/or to reduce errors in the generated DT. That is, a possible deviation between the generated DT and the provided DT may be reduced. For example, it may be determined by use of the generated DT that the provided DT has some deficiencies or is outdated or is unable to consider some of the stimuli that actually occur during runtime of the network entity. Such a provided DT may therefore be updated or enhanced by use of information from the generated DT. Alternatively or in addition, using the generated DT may face, e.g., ambiguities in the model or other issues that may be overcome by having additional information from the provided DT.

According to embodiments, generating the DT may be performed, for example, during a manufacturing or calibration of the network entity. The method may comprise storing the DT in a memory accessible for one or more entities. That is, not only the network entity itself may have access to the memory, but also, for example, the network node or different nodes. The method further comprises accessing the DT with the one or more entities. For example, the DT may be made accessible for one or more network entities, e.g., stored as a file in the cloud of the internet or a different memory. For example, such a central memory may allow to describe the network entity or network node and its behaviour.

Such entities to access the model may comprise at least one authorized entity, a recognized entity and/or a requesting entity. Although those entities may provide partly for a similar function in the network, the entities may implement different tasks. For example: An authorized entity might include a device or apparatus operated by a regulator or some other government agency or the like and may provide or execute or monitor specific regulations or the like, i.e., the authorized entity may be authorised by an entity external of the network. A recognized entity may be the MNO (or a device implementing the corresponding functionality) to which the WCS/RAN belongs. Alternatively, the recognized entity may or a second MNO (or a device implementing the corresponding functionality) having an agreement with the first MNO (also to include roaming). A requesting entity is possible neither an authorized entity nor a recognized entity but nevertheless its request is capable of being accepted/rejected by the first MNO. In view of the above, a provision and/or a use of a DT of a network entity by an authorized entity, a recognized entity and/or a requesting entity may allow to monitor and/or control the operation and/or behaviour of the network beyond the boundaries of the wireless communication network itself, which may provide for advantages also in view of interoperability between different networks or radio access technologies, RATs. According to an embodiment, the DT may be provided with a different granularity to entities having different priorities such that a priority is associated with a granularity. The granularity may relate to a preciseness with regard to the stimulus and/or behaviour and/or to a size of a set of stimuli and/or behaviours to be modelled or the like.

In other words, a DT can be exposed to an entity in the same network or to entities belonging to other networks. This can be done in a layered approach e.g. exposing different functions or details depending on the network the other entity e.g. 3PC belongs to. A 3PC in that context could even not belong to any network, being a higher authority itself e.g. as a regulator or a spectrum watchdog. However, this is only an example for exposing the DT in the wireless communication network. Exposing may also relate to simply providing or transmitting the DT to an entity and/or to pointing towards a storage medium in the wireless communication network or a different network where the DT is stored and/or accessible.

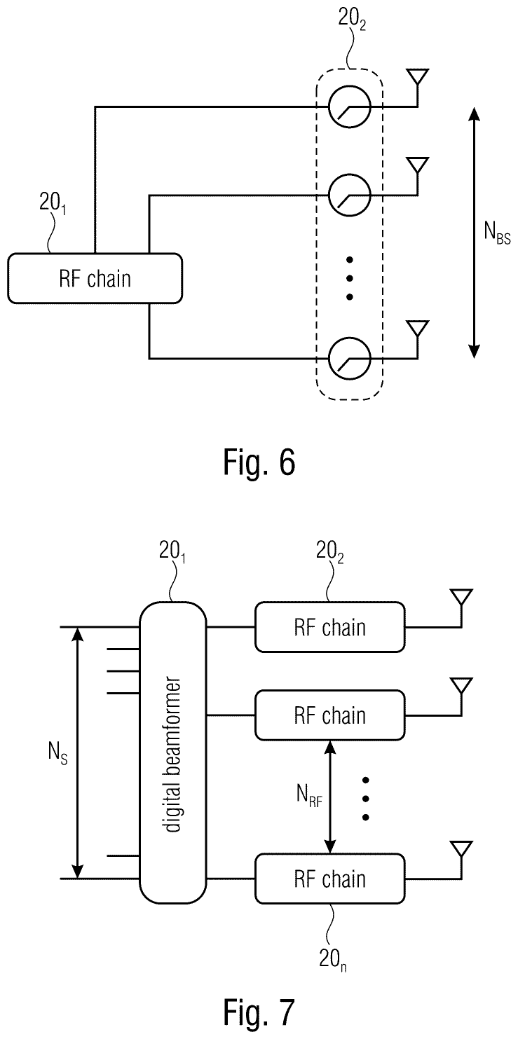

According to embodiments, the DT may be used to understand and/or to predict the behaviour of the network entity, e.g., as a performance characteristic or the like. However, such characteristics may not only relate to a single network entity but also to a combination of entities. In view of this, embodiments are also related to having a DT as a combined DT. Such a method may comprise obtaining a first DT of a first component, e.g., one or more network entities or parts thereof, of the wireless communication network and obtaining a second DT of a second component of the wireless communication network. Both DTs may be combined to arrive at the combined DT. Such a combined DT may allow to understand and/or predict the behaviour of the combination of components. Examples for a combination of components are given in connection with FIGS. 6 to 17. A component may relate to a network entity, a part thereof, e.g., an essential part when referring to network operations and/or a combination of entities.

### Beamforming

High quality beamforming is necessary for the integrity of phased array antenna systems such as those deployed in 5G and beyond 5G wireless communication systems. Until recently, beamformers were realized as hybrid or monolithically integrated analogue sub-systems in which their wideband operation was plagued by higher loss, amplitude and phase imbalances and the such like. Such impairments contribute to errors in beam-pointing and geo-location and to general antenna pattern contamination. An example of a generic analogue beamformer is shown in FIG. 6. FIG. 6 shows an analogue beamforming (ABF) at the base station where all antenna elements share a common or single RF chain through a phase shifter (contained within the blue coloured shape). The number of antennas at the base station is denoted by NBS.

FIG. 7 shows a schematic diagram of a digital beamforming (DBF) at the base station where each antenna element requires a separate RF chain. The number of data streams is denoted by N_{S} and the number of RF chains at the base station by N_{RF}. In contrast to fully-digital designs in which the spatial processing is performed in a baseband unit that uses the flexible computational resources afforded by digital processors (see for example FIG. 7), analogue beamforming schemes require analogue components, such as phase-shifters, time delay elements, variable gain amplifiers and attenuators or switches. While such analogue components do not have the same processing flexibility as the digital processor, they can substantially reduce the cost and complexity of the beamforming solution and simplify its implementation. In a hybrid analogue-digital scheme therefore, the number of radiofrequency chains can be reduced by distributing the processing in both the analogue and digital domains, thus reducing overall costs and digital bandwidth requirements.

Hybrid analogue-digital schemes have been used in the past for both radar and communication systems. These types of beam forming structures have two separate processing parts-one in the analogue domain, the other in the digital domain. Here, the digital processing uses computational resources while the analogue processing employs RF components such as phase shifters or switches. While a phase shifter controls the phase of an RF signal, the switch either connects or disconnects an RF chain to an antenna. The switching operation can be modelled as a binary variable and the phase shifter as a unit-norm complex variable.

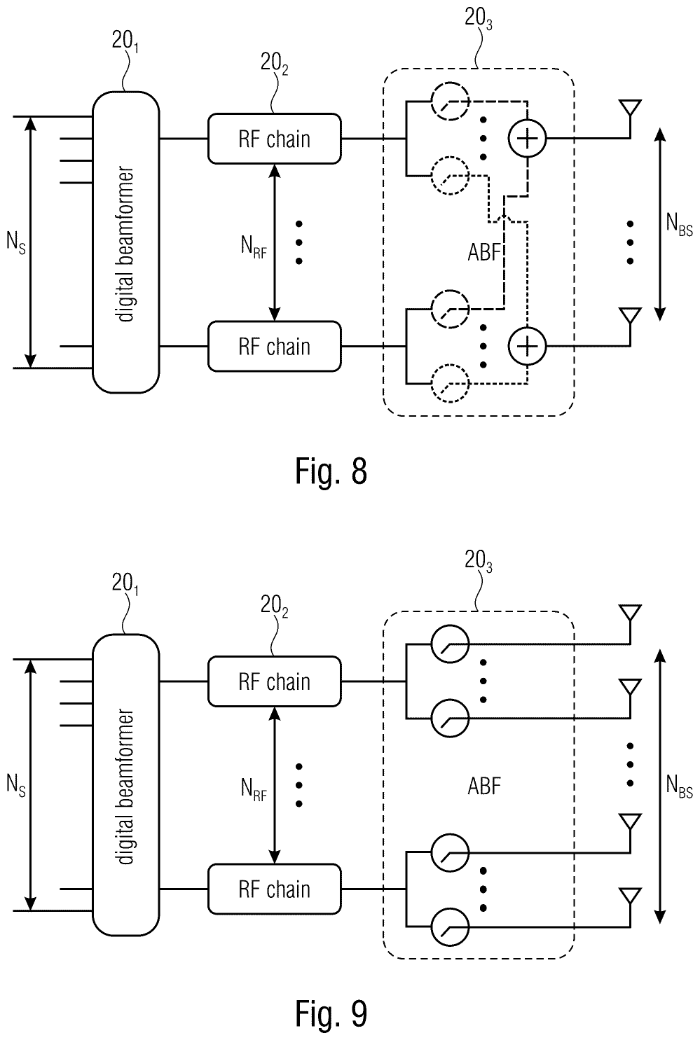

Although there are various hybrid analogue-digital beamforming architectures in existence which differ in their method of connecting the RF chains to the antenna, in general, each RF chain of the digital part is connected with one or more antennas via analogue components. The most complex scheme is hybrid fully connected in which each RF chain is connected to all antennas (via an analogue component). FIG. 8 presents a fully-connected scheme with phase shifters. FIG. 8 shows a schematic block diagram representing a fully-connected HBF architecture at the BS in which all RF chains are connected to all antennas. The ABF contains a large number of phase shifters in order to fully map all RF chains to the antennas. The number of data streams is denoted by N_{S}, the number of RF chains at the base station by N_{RF} and the number of antennas at the base station by N_{BS}

In order to substantially reduce the number of connections and analogue components other connection methods can be used; namely, localized and interleaved. Whereas a localized architecture connects each RF chain a subset of sequential antennas (see FIG. 9), the interleaved scheme interconnects the different RF chains with separated antennas. As the RF connection lines tend to be longer in an interleaved scheme compared to a localized scheme, the implementation complexity and losses are higher. On the other hand, however, the interleaved scheme offers greater flexibility in terms of its configurability. FIG. 9 shows a schematic block diagram representing a partially-connected HBF architecture in which each RF chain is connected to a subset of all available antennas and every antenna is attached to a phase shifter. The number of data streams is denoted by N_{S}, the number of RF chains at the base station by N_{RF} and the number of antennas at the base station by N_{BS}.

The figures presented thus far in this section have illustrated some of the various architectural implementations of beamforming transceiver realizations and have thus attempted to provide a simplistic understanding of the complex connection between the radio unit and the antenna unit.

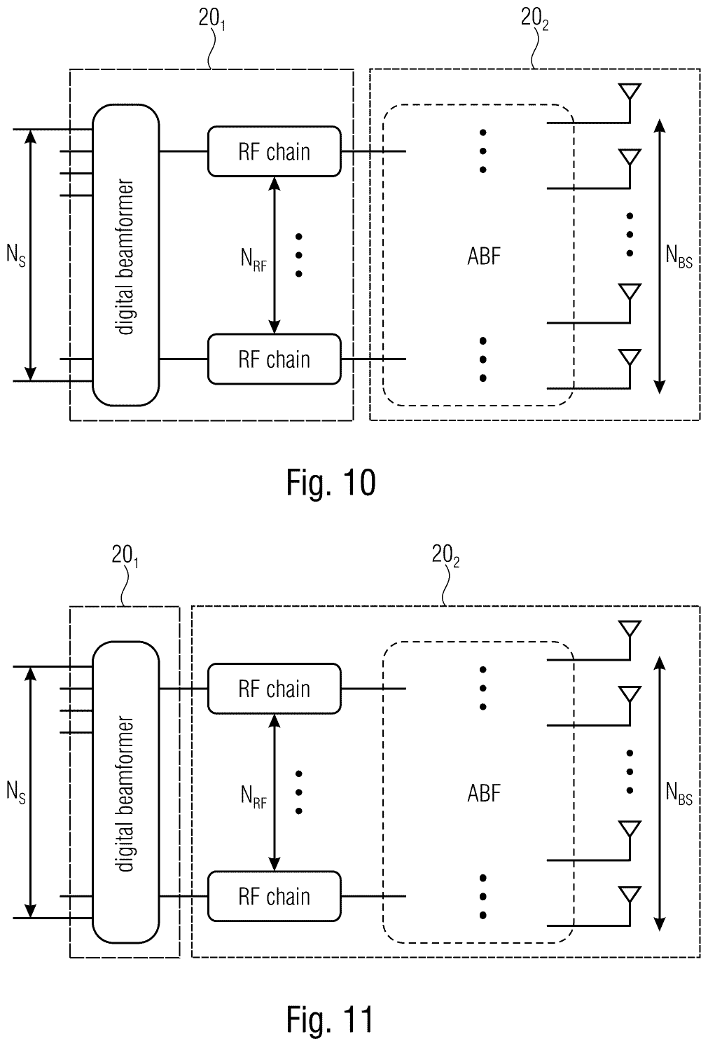

FIG. 10 presents a simplified and generalized representation of both the fully-connected and partially-connected hybrid beamforming systems shown earlier in FIG. 8 and FIG. 9, respectively, with the difference that certain functional components of the system have been grouped. That is, FIG. 10 represents a first hybrid beamforming architecture comprised of two blocks. The first block contains the digital transformer and RF/IF chains and the second block contains the analogue beamformer and antenna array elements. An alternative grouping of similar components is presented in FIG. 11 showing a schematic block diagram representing a second hybrid beamforming architecture comprised of two blocks. The first block contains the digital transformer only and the second block contains the RF/IF chains, the analogue beamformer and the antenna array elements-further permutations are not precluded.

Partitioning can be done in various ways and the result of which will influence the type of interface used between the partitioned blocks. For example, FIG. 10 shows an analogue interface (operating at IF or RF) whereas in FIG. 11 the interface could be either analogue or digital depending on the placement if the ADCs and DACs.

In order for the hybrid beamforming systems presented above to operate and perform correctly, digital twins of the left-hand side block can be used by the right-hand side block and vice versa. This not only allows the two blocks to effectively work together as a single and combined unit but also permits other blocks with suitable functionality to replace one of those that is already used. With respect to FIG. 10 for example, a different type of antenna array and associated analogue beamformer such as a partially-connected or a fully-connected implementation could be interchanged. In a similar manner, and now with respect to FIG. 11, the digital beamformer could be exchanged for example according to the requirements of the number of streams to be supported. Common to all of these solutions is the availability and integration of a digital twin.

### The Deployment of a Third-Party Controller

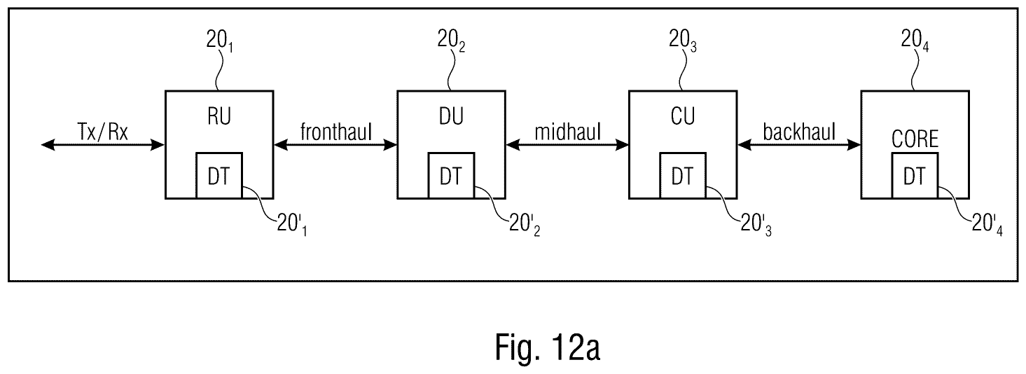

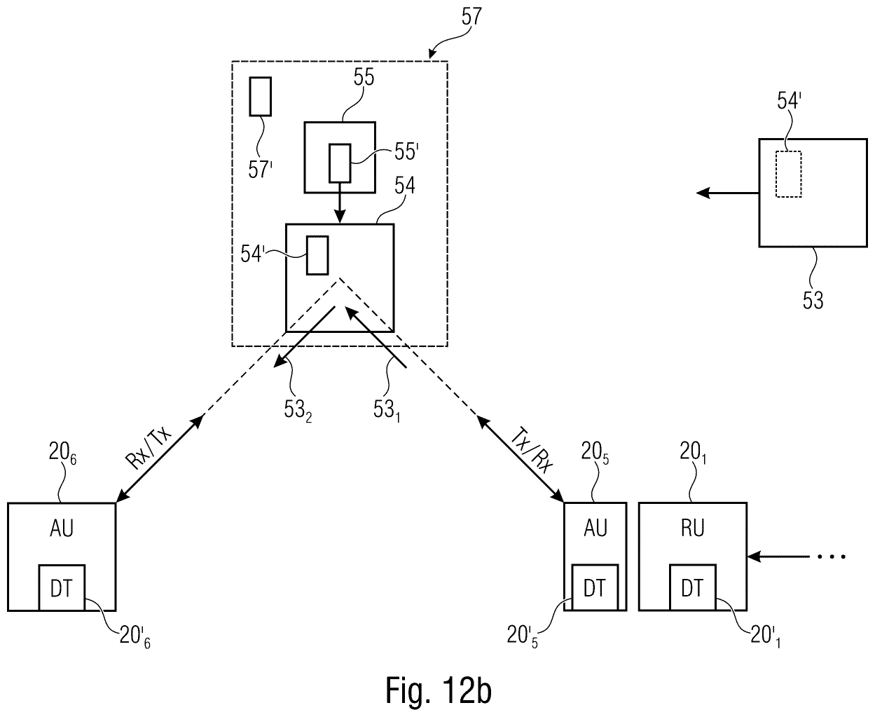

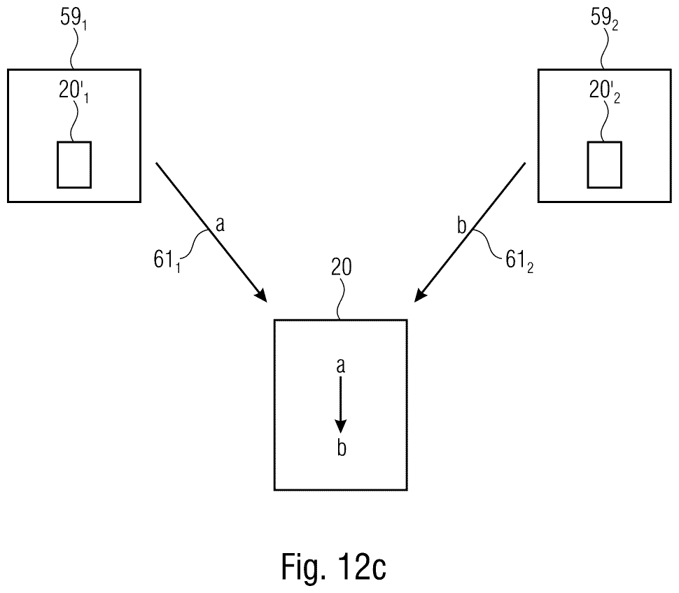

FIG. 12a is a functional block diagram showing the arrangement and connection of radio unit (RU), distributed unit (DU), centralized unit (CU) and core using fronthaul, midhaul and backhaul interfaces, respectively. FIG. 12a shows a simplified interconnection diagram that shows the RU, DU, CU and CORE units and their interfaces. The radio frequency interface (Tx/Rx) is also shown even its connection to the antenna unit (AU) has been removed for convenience. In the example of FIG. 12a a Digital Twin (DT) is associated with each of the following: the Centralized Unit; the Distributed Unit; and the Radio Unit. What is not shown however, is the Antenna Unit—this too can have its own associated Digital Twin.

As discussed earlier, since the functionality of one AU can be quite different to that of another AU, it is important that a detailed understanding of this functionality is available to other units that interface to the AU, either directly—such as the RU—or indirectly, as is the case for the CU or other entities of the WCS. The concept of controlling the AU is thus introduced.

The entities depicted in FIG. 12a may be realized as hardware components that use (either primarily or exclusively) digital input and outputs. Such inputs and outputs may therefore be described as bit patterns, voltage levels, pulse shapes, pulse widths, slopes, sequences and so on while internally the functional behaviour is realized in the digital domain only (with exception of the RU). This allows the digital twin to hold an accurate model that precisely represents such components. Greater complexity is associated with the DT of the AU wherein the inputs and/or outputs (e.g. the radiating antenna elements, the antenna array and the IF/RF chains) usually include analogue signals and further analogue signal processing components (e.g. phase shifters, time delays, amplifiers, combiners, splitters, filters, attenuators etc.) as described above. As a result, a DT of network entities, units or modules containing analogue components has to be represented by a DT capturing all states, transitions and behaviour which are observed when operating the real entity, unit or module in a WCS.

By providing a DT of entities, units or modules other entities can interact with these via a suitable interface thus allowing different entities to interoperate even when provided by different vendors. Although the digital twins 20′₁-20′₄ are shown to be hosted or operated at the respective entity 20₁ to 20₄, the DT may be hosted or operated, as an alternative or in addition, at any location, e.g., at a remote controller such as an OEM controller or a third party controller and/or a central entity providing a respective service, and/or may be accessed, e.g., using a data connection, from any location. That is, FIG. 12a is to be understood as showing a relationship or association between the entities 20₁ to 20₄ and the respective DTs 20′₁-20′₄ but not necessarily a location of a controller operating the DTs.

FIG. 12b shows a schematic diagram of parts of the entities of FIG. 12a in which the antenna unit, AU, of FIG. 12a is shown as entity 20₅ that may optionally be represented by a DT 20′₅ and that provides a unidirectional or bidirectional wireless communication Tx/Rx with another antenna unit 20₆ that may optionally be represented by a corresponding DT 20′₆ and that may form a part of a different network node, e.g., a user equipment, a base station, a relay, an internet-of-things, IoT, device or the like. A reconfigurable intelligent surface, RIS, 54 may be part of the scenario. The RIS may deflect or reflect an incoming wireless signal 53₁ to an outgoing deflected or reflected wireless signal 53₂. Although also an active generation of signal 53₂ responsive to a reception of signal 53₁ is possible, e.g., comparable or according to a relay operation, the RIS may change the property of deflection or reflection. The property and/or a change thereof may be controlled by a RIS controller, RISC, 55, the RIS controller possibly forming a common network node 57 with the RIS itself. However, RIS controller 55 may be a remote controller and, for example, be located at or accessible from a remote location. The RIS controller 55 may, thus form at least a part of a network node, wherein the RIS 54 and/or the RIS controller 55 may be modelled individual or in combination by a respective DT 54′, 55′, 57′ respectively or in combination. The RIS controller 55 may be in communication with further entities or nodes, e.g., for receiving commands or requests.

The RIS may be controlled, for example, with regard to at least one parameter relating, for example, to a polarisation of signal 53₂, a direction of signal 53₂ a focussing of signal 53₂, e.g., using a beamforming technique, a gain factor or the like and may thus, provide for an actively controlled influence in the radio propagation channel used for communication, e.g., to provide for additional propagation paths.

By controlling the RIS 54 by use of a DT 54′, 55′ and/or 57′, communication between entities 20₅ and 20₆ or between the respective network nodes may be enhanced by not only considering the behaviour of network nodes communicating with each other but also of intermediate entities such as the RIS 54.

The RIS 54 and/or the RIS controller, RISC, 55 may be an important element or function of the network that is used, in effect, to affect changes in the propagation channel. For example, a controller entity 59 such as a third part controller (3PC) may be used to control a network entity in the form of an equipment (radio transceiver, antenna unit, scheduler, core component), the RIS controller may attempt to control the channel that forms part of the communication link.

Although the RISC 55 and the controller 59 may be different elements, devices or units or functions, the controller or 3PC may also be part of the RISC 55 and/or form a common controller device, entity or function with the RISC 55.

The controller 59 may alternatively or in addition be adapted to control other entities and/or network nodes, e.g., using a DT of such an entity, a related entity or other components of the wireless communication network. Such a structure may allow to operate a plurality of controllers 59 in a wireless communication network, e.g., simultaneously and/or alternatingly.

In some cases an operation of multiple controllers 59 or at least the ability to operate a set of controllers in the wireless communication network may benefit from rules for such competing or cooperative operation of multiple controllers to organise the operation thereof.

For example, a hierarchy may be implemented that allows the controlled entity to prioritize received commands and to act contrary to some commands, e.g., when contradicting commands received from higher hierarchy. According to an embodiment, a method of claim may comprise applying a hierarchy between the first controller and the second controller. According to an embodiment, the method comprises counteracting a first command from a controller of lower hierarchy in favour of a contradicting second command from a controller of higher hierarchy.

According to an embodiment, the hierarchy is related to one or more of:
a type of controller;
an operator of the controller;
a user class associated with the controller;
an authorisation associated with the controller

FIG. 12c sows a schematic diagram illustrating a part of a network according to an embodiment. Controllers 59₁ and 59₂ may use DTs 20′₁ and 20′₂ of entity 20₁ e.g., a RIS, e.g., to control the entity 20 by sending commands 61₁ and 61₂, e.g., by transmitting wired or wireless signals with interfaces adapted for providing such a transmission. It is to be noted that the DTs 20′₁ and 20′₂ may be hosted at the controllers 59₁ and 59₂ or at a different entity, e.g., they may be a same DT at one of the controllers or at the different entity. Alternatively or in addition, the 20′₁ and 20′₂ may relate to the same entity 20 and may comprise a same or different amount of information or granularity.

Both controllers 59₁ and 59₂ controlling entity 20 may benefit from a hierarchy in which, making use of the concepts described herein, one of the controllers, e.g., 59₁ may have a higher hierarchy when compared to the other controller, e.g., instruction a may be executed prior or instead of instruction b.

A hierarchy may be based, for example, on a user class (e.g., an amount of data transported, an importance of the operator for the network, service class payments or the like), a device class, e.g., a type of controller.

For example, in case the controllers 55 and 59 are not the same, in other words there is one or more 3PC 59 and there is one or more RISC 55, a hierarchy might be implemented in the wireless communication network, e.g., by a protocol, regulatory rules or the like that cause the wireless communication network for a corresponding operation. Examples of such hierarchy rules may relate to but are not limited to include:
a type of controller (i.e., 3PC-type or RISC-type), i.e., a type may have a higher hierarchy than onother
one of the controllers (i.e., one of the total set of 3PCs and RISCs)
individual controllers that form the set of 3PCs
   i. individual 3PCs with regard to commands provided
individual controllers that form the set of RISCs
   i. individual RISCs with regard to commands provided
the sets of controllers that are comprised of specific 3PCs and RISCs
e.g., within 3PCs only
e.g., within RISCs only
sensible (meaning that they work) combinations of the above
individual RIS, e.g., to a sequence of commands to be executed

When referring to the RIS, same may be a part of a wireless communication network but may also be used, recognised and/or controlled by entities belonging to different wireless communication networks, e.g., operated by different MNOs. A controller 59, e.g., a 3PC may be an identifiable entity of a given network and may, thus, belong to an MNO and/or be controlled by a single MNO. A RISC—which can be so configured to affect the propagation channel so as not only to improve the communication between two or more network entities but also to mitigate the interference experienced by network entities-might not be so easily identifiable as an entity of a single network and the scenario may benefit from a control by:
One or more MNOs
Regulators
Higher authorities
Other government agencies

A hierarchy may alternatively or in addition be applied to the MNOs, regulators, higher authorities, government agencies or other authorities, e.g., one over the other and/or within such a group.

Such operation or hierarchy may be useful or even necessary for
separate controllers to exchange information:
   i. Between controllers of the same type (i.e., between two controllers such as 3PC₁←→3PC₂ and/or RISC₁←→RISC₂ etc.)
   ii. Between controllers of different types (i.e., 3PC₁←→RISC₁ and or/or 3PC₂←→RISC₂ etc.)
Groups of controllers to exchange information:
   i. Between similar controller types
   ii. Between different controller types
For the flow of information to be
   i. in one direction only (e.g., a first type of controller may accept information or instructions only rom a second type of controller, e.g, 3PC→RISC or RISC→3PC)
      ii. In both directions

In view of this, embodiments relate to the use of a DT of a RIS/RISC by more than one instances which may be equivalent of hosting or operating more than one DT for a same entity. For the more than one instance(s) a hierarchy with regard to instructions may be associated.

Such embodiments may relate to one or more entities using accessing or hosting a DT. Such a method may comprise controlling the network entity, e.g., a reconfigurable intelligent surface, RIS, based on the DT, with at least a first controller and a second controller of the plurality of entities.

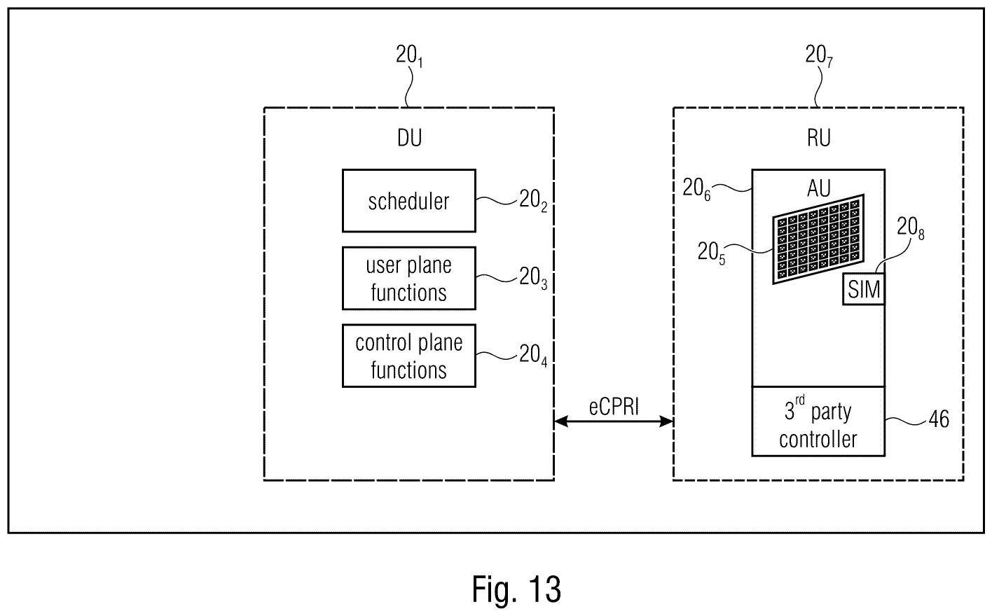

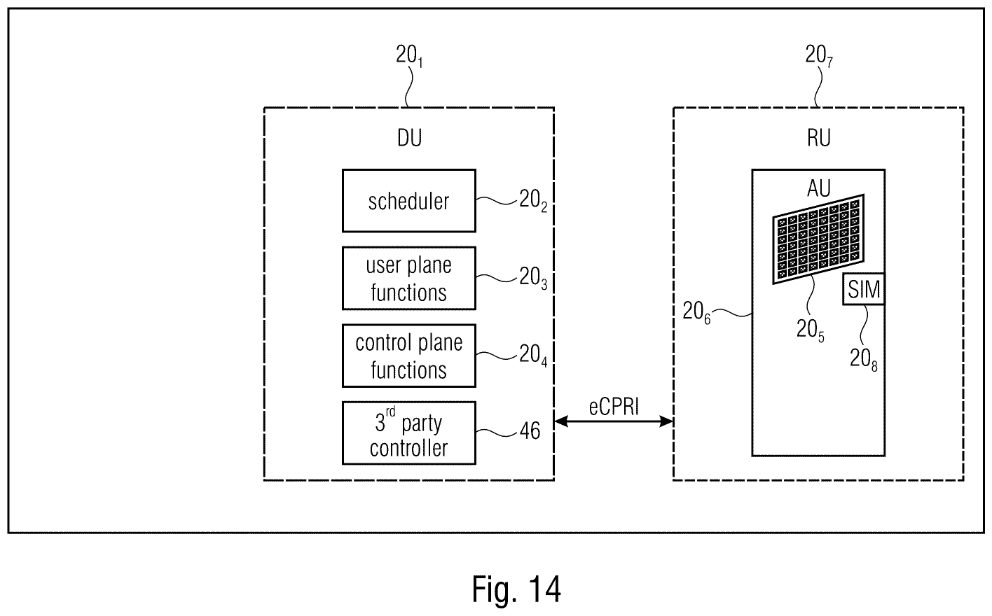

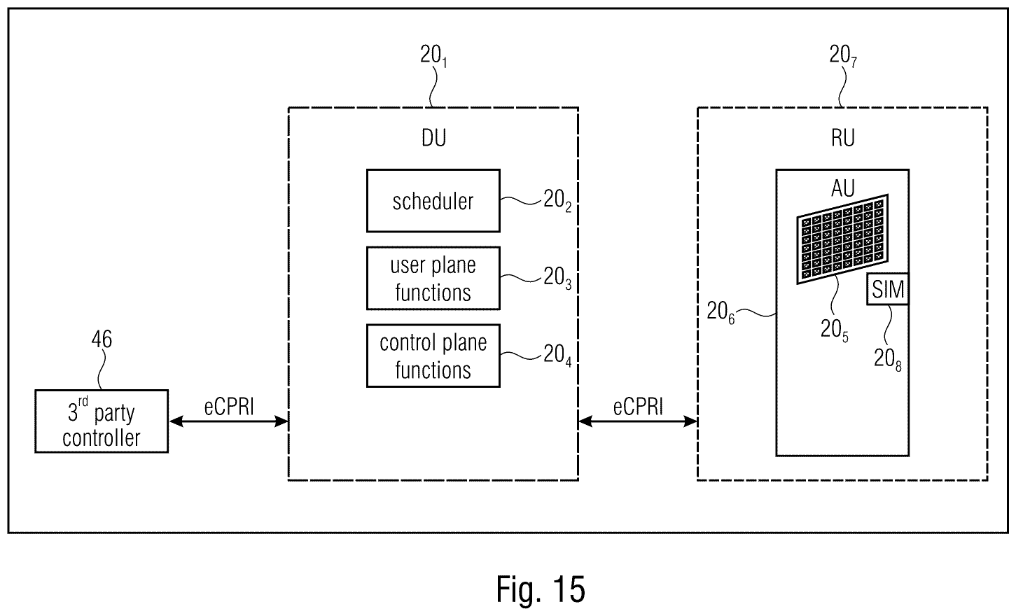

FIG. 13, FIG. 14 and FIG. 15 provide three examples of how a controller 46 which may be operated by a manufacturer as well as other instances such as a third party, the controller 46 forming an embodiment of the present invention, can be integrated into the WCS. The controller may implement at least parts of methods described herein and may use a DT to control a controlled entity.

In the first example, the controller 46 is placed inside of the radio unit. The second example of FIG. 14 shows the controller 46 contained within the functionality of the distributed unit being also a network entity 20₁. Finally, the third example shows the controller 79 placed elsewhere in the WCS and connected via an interface such as eCPRI.

As before and therefore in all three examples, a digital twin of the AU is available to the RU, the DU and elsewhere, respective to the order of the figures presented.

Further variations that use alternative controller implementations are not precluded.

In the embodiment of FIG. 13 an open eCPRI interface allows a connection to be made between the Distributed Unit and the Radio Unit, the latter being further comprised of the Antenna Unit and a third-party controller. Since the controller has access to the AU's digital twin, full control of the proprietary antenna unit is facilitated.

In the embodiment of FIG. 14 an open eCPRI interface allows a connection to be made between the Distributed Unit and the Radio Unit, the latter being further comprised of the Antenna Unit only. The third-party controller is integrated in the DU and since it has access to the RU's and hence AU's digital twins, full control of the proprietary antenna unit is facilitated.

In the embodiment of FIG. 15 an open eCPRI interface allows a connection to be made between the Distributed Unit and the Radio Unit and between the DU and a third-party controller. Since the latter has access to the RU's and hence AU's digital twins, full control of the proprietary antenna unit is facilitated.

### Using a Third-Party Controller

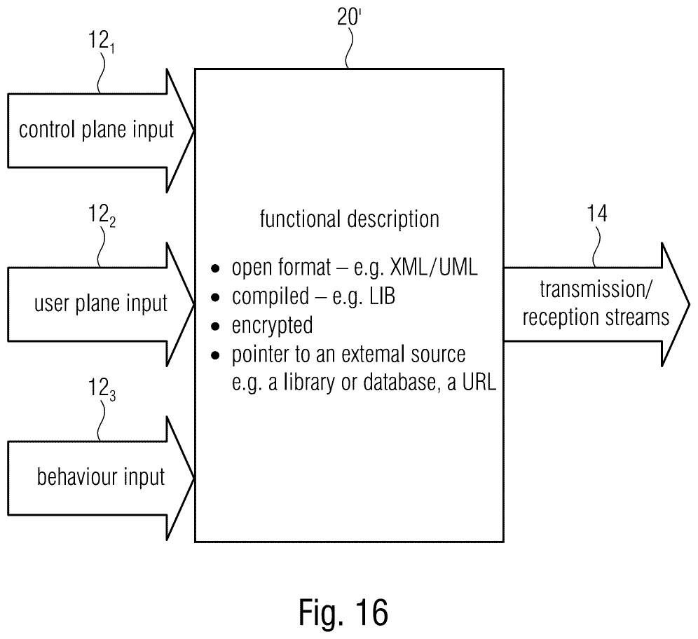

FIG. 16 depicts a schematic representation of the signals that are to be transmitted to a network entity, unit, controller or module. That is, FIG. 16 is a functional description of the elements that could comprise a digital twin and its connection to other streams. User and control plane inputs usually include signals related to the communication with a user equipment (UE) wherein the control plane data is used to control the communication. The user plane date represents the content (payload) to be communicated and/or exchanged with the UE. It is to be noted that such a third party controller may control one or more network entities and/or one or more network nodes at least partly, e.g., at least a part of a network core, at least a part of a CU, at least a part of a DU, at least a part of a RU, at least a part of an AU, at least a part of a RIS or combinations thereof.

FIG. 16 also shows a behaviour (control) input or a behaviour plane which allows, amongst other things, a third-party controller (3PC) to adjust, influence or control the behaviour of the network entity, unit or module. This allows the 3PC to process and/or forward the control and user plane data/signals in a designated or desired manner to the UE or to another entity in the network. For simplicity, it should be noted that the figure has been drawn primarily with respect to the purposes of transmission towards the UE in the so-called downlink direction. This does not however exclude the application of the techniques to the opposite uplink direction.

With reference to FIG. 16, the box 20′ shown in its centre may represent the DT of a network entity, unit or module, wherein the behaviour 14 and the transmitted or received streams of the DT and the (“real”) network entity, unit or module will be identical within the measurement accuracy selected for approximation by the DT. The DT 20′ may provide the behaviour as a response to inputs 12₁ to 12₃ coming from a control plane, CP, a user plane UP, and/or from a behaviour input 12₃, e.g., a targeted behaviour and/or a recognized behaviour of other nodes. However, the illustrated arrows and their directions may, as an alternative or in addition, be inverted, e.g., to derive the stimulus based on the behaviour 14.

A 3PC can be implemented as a network element on dedicated hardware, as a software instance running on a dedicated hardware, or as a virtualized function instantiated on an appropriate platform such as a cloud infrastructure.

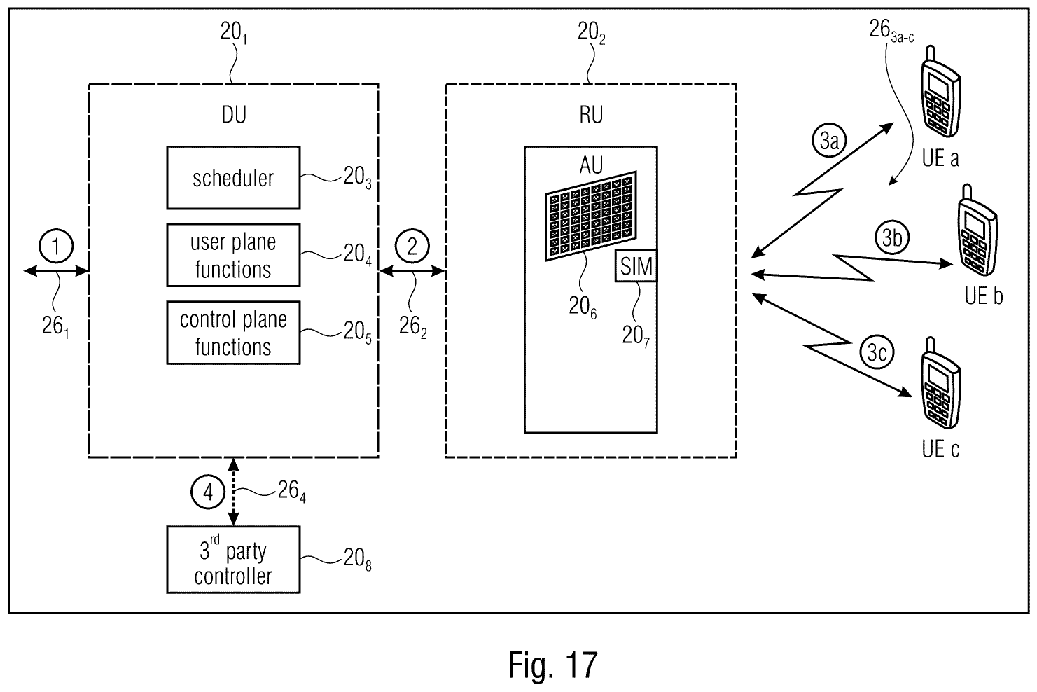

FIG. 17 shows a functional diagram showing the interfaces between the core network, a distributed unit, a radio unit together with an antenna unit, several user equipment devices and a third-party controller (3PC). To help explain the operation of a 3PC within a WCS, FIG. 17 illustrates the interfaces between various network entities including the 3PC itself, a DU, an RU and a number of UEs—for simplicity, the CU and core network have not been shown. Numbers 1, 2, 3a, 3b, 3c and 4 relate to interfaces 26₁ to 26₄. These interfaces, each labelled with an encircled reference, and the signals they carry are described as follows:
1, 26₁ respectively depicts the interface between the CU (not shown) and the DU, typically implemented using an Ethernet or IP-based interface over cable and/or fibre carrying:
   core network signals.
2, 26₂ respectively depicts the interface between the DU and the RU, typically implemented using an open eCPRI interface over cable and/or fibre carrying:
   UP and CP signals targeted for specific UEs; and
   Behaviour plane (BP) to the AU and/or RU including receive status signals or reports that are used to update the states and/or parameters of the AU's DT. For example, a change of temperature in the AU may affect its performance and could therefore trigger a behaviour change instruction.
3a, 3b and 3c, 26₃ respectively depict the wireless or air interfaces between the AU (shown within the RU) and three UEs—UE a, UE b and UE c-which carry:
   UE specific UP and CP signals; and
   UE specific measurement and reporting signals.
4, 26₄ respectively depicts the interface between the 3PC and the DU (while the figure shows the 3PC connected to a single DU, in practice the 3PC could be connected to multiple DUs of the same or of different WCSs), typically implemented using a digital interface such as open eCPRI or Ethernet or IP-based over cable and/or fibre carrying:
   from the DU to the 3PC:
      low-, mid- and high-PHY feedback signals including the measurement of reference signals (RSs), packet errors (PEs) and signal-to-interference-plus-noise ratio (SINR);
      scheduler signals;
      signals from the CN; and
      user feedback on measurements done by a specific UE.
   from the 3PC to the DU:
      signalling to the scheduler;
      signalling to a specific UE via control plane e.g. RRC; and
      signalling to the CN if needed.

Each of the shown entities, e.g., a DU or one or more components thereof, e.g., a scheduler, user plane functions, control plane functions, an RU or one or more components such as an antenna unit, AU, or a Subscriber Identity Module, SIM, may, as well as UEs or parts thereof, be represented as a DT or, in any combination with other entities or components form a part of a combined DT, as may be obtained, for example, when modelling the DU 20₁ and/or the RU 20₂ as individual twins having a combination of components or as a combined DT.

The interfaces described above are required to configure, operate and optimize the AU in that given example including closed loop feedback from low-, mid- and high-PHY from the UE and/or the DU. Signalling between the core network (CN) and the 3PC may further enhance performance of the AU in the WCS and/or be required in order to obtain important information such as centre frequencies, transmit power etc. which are usually set and controlled in a centralized manner in the WCS.

It should be noted that a 3PC can also be represented by its own DT.

### Network Exposure Function

Within a WCS, for example the 3GPP core network, an application function (AF) may interact with the 3GPP Core Network via the network exposure function (NEF) in order to access network capabilities. The digital twin of a network entity can be considered to be an application function (AF) and is thus made known (or “exposed”) to other entities through the NEF. A rationale behind the concept of the next work exposure function may be described as follows:

A 5G Network Exposure Function (NEF) may facilitate secure, robust, developer-friendly access to exposed network services and capabilities. This access may be provided by a set of northbound RESTful (or web-style) APIs from the network domain to both internal (i.e., within the network operator's trust domain) and external applications. The NEF may be an analogous function to the 4G Service Capabilities Exposure Function (SCEF). A combined SCEF+NEF node may be necessary to hide the specific network technology from applications and user devices that can move between 4G and 5G. Therefore, flexibility on the southbound network interfaces may also be an essential feature for integration with 4G core end-points using the Diameter protocol and with 5G core end-points via the service-based interfaces that are specified as part of the new 5G Core Service Based Architecture (SBA).

As a network exposure it may be understood making the network capabilities easily available for customers and partners to innovate on. The network can be connected to ecosystems and enrich applications with its data and resources. To expose the DT may form at least a part of the network exposure function implemented in the wireless communication network.

Network exposure, or service exposure within the network domain, may relate to making network capabilities, such as data and network services, easily available for customers and partners to innovate on. With assigned security and data integrity policies, network data and resources can be accessible for different ecosystems to enrich enterprise applications.

Network exposure may be an important function to meet the requirements of use cases for e.g. in IoT, XR, smart manufacturing and automotive sectors. Exposure may even be critical to achieve programmable networks that can communicate with all IoT devices, handle edge loads and introduce and monetize new 5G use cases and business opportunities.

In 5G, communications service providers and enterprises can easily activate new capabilities and expose them through APIs, boosting the programmability and adaptability of connectivity services to fit different needs. The core network provides adaptors connecting the southbound interfaces and business logic to create network APIs to third-party developers.

Adopting the rationale of network exposure functions is aimed to provide easy access to third parties via APIs thus introducing new services and the such like. Embodiments provide similar functionalities to interconnect an AU or RU to e.g. a 3PC via a suitable API. In the context of provision of DTs the exposure to the network and its network entities in accordance with embodiments include the capability to provide a DT with respective details, among these representing e.g.:
Functions
Capabilities
Features
Interfaces including states, parameters etc.
Description model (layered or as a whole)
Behaviour model

As a feature, one may understand an attribute, function or aspect of something. This means that components, entities, nodes or combinations thereof such as the RU and/or AU can be exposed to the network in a way similar to a printer in a home or enterprise network, wherein the device (printer) advertises its existence coming along with an identity and an API which allows computers and other devices like smart phones or tablets to connect, configure certain print tasks and execute a print task.

In the context of a DT coming along with an AU and/or RU the network element, unit, module or submodule, the existence of a DT of such a module will be exposed/advertised to the network either as part of the AU/RU, stand-alone or as a combination of the two. After an initial handshake protocol between the 3PC and the AU/RU and exchange of access and control credentials, the DT can then be made accessible to be used within configuration and operations procedures. Furthermore, through the description of the interfaces, parameters etc. a 3PC is able to exploit the full potential of the DT during planning, configuration, operation, optimization, maintenance and decommissioning of the physical unit which is represented by the DT.

Furthermore, conceptually a device e.g. a smart phone maybe provided with a DT of its embedded AU therefore being enabled to use the DT for e.g. optimization of beamforming, estimating a radio propagation channel more accurately and extrapolating beyond effectively measured signals and parameters having a model of its own behaviour e.g. antenna radiation patterns etc.

Through the network exposure function a device or a network entity can reveal its controlling and/or controlled one or more entities, for example itself or one or more 3PCs. Through the use of DTs multiple 3PCs can coordinate the control of a given device or network entity. Coordination can be arranged in a hierarchical, cooperative, cognitive, sequential, distributed, localized or task-oriented fashion.

In the following, some application examples are given to highlight the benefits of the present invention. However, although defining concrete applications, those examples do not limit the scope of the present invention.

### Application Examples

### Example a (Real-Time Radio Intelligence Controller (RT-RIC))

gNB←→UE (Each Device has a Digital Twin of at Least the Other Device)
Observe radio channel in a first and/or second direction
Combine observation with digital twin to determine propagation channel
Optimize beamforming at least at a first end of the link
Reduce feedback for reporting e.g. CSI+codebook entry (digital twin provides side knowledge)

A method, in connection with example A may be implemented such that the DT is a first DT of the network entity being a first network entity forming at least a part of a network node. The method may comprise to use a second DT of a second network entity forming at least a part of a second network node communicating with the first network node to a radio propagation channel. The method may further comprise to determine a propagation of a radio signal along a first direction from the first network node to the second network node and to determine a propagation of a radio signal along a second direction from the second network node to the first network node using the first DT and the second DT.

In a further example, this method may further comprise to observe a radio channel between the first network node and the second network node for at least one direction between the first network node and the second network node, e.g., from the first network node towards the second network node and/or from the second network node towards the first network node, to obtain a radio channel information. The radio channel information may be combined with the first DT and the second DT to determine the radio channel propagation. The radio channel information may thus form at least a part of a stimulus and/or a behaviour. Further, a beamforming of the first entity and/or the second entity may be optimized for the radio channel. This may allow for obtaining an optimized beamforming without forming a real beam in a test procedure or to reduce a number of physically formed beams during a test procedure.

### Example B1 (Localization, Radio Map Planning, Site Specific AAU Configuration)

A transmitting device with multiple distinguishable radiation patterns together with digital twin allows the determination of both the location and the orientation of the device relative to a propagation environment. For example, a warehouse automatically guided vehicle (AGV) or an unmanned airborne vehicle (UAV).

Example B2: measurement inputs from real world measurements e.g. CSI, CQI, etc. maybe an input to a ML algorithm which may conclude/deduce a DT or a radio environment map around the BS. Furthermore, provided knowledge of the DT of the AAU/RRU may allow to derive a DT of the radio propagation environment in at least the cut where the measurement samples were taken. Such a method may comprise to use a DT for a localization of the network entity and/or for a mapping of an environment of the network entity. As the behaviour of the network entity may be predicted, at least a part of a stimulus may also be represented by an environment and/or a localization of the entity in the modelled environment. That is, obstacles, buildings or other objects as well as free fields may interact with the object, for example, in view of a movement and/or a propagation of radio waves, which may be modelled in a DT.

Example C (MDT—with Pre-Compensation of Measurements by Knowledge about DT)

Consider a beamforming UE that suffers from poor spherical coverage. By using knowledge of relative orientation (see example B) and angle-of-arrival (AoA) and/or angle-of-departure (AoD) of multipath propagation channel to predictively adapt beams. Such a method may comprise to use information indicating a relative orientation and information indicating an angle of arrival of an incoming radio signal and/or an angle of departure of an outgoing radio signal to adopt a beam pattern formed with a network node comprising the network entity.

### Example D (Conformance/Performance Testing, Failure Analysis/Trouble Shooting)

Such a test may comprise to perform measurements, e.g., to measure a beamwidth of a physical entity. The results may be compared with an expectation, e.g., it may be expected to have a beamwidth of 5°. The expectation may be compared with the result being obtained from a DT modelling the measurement and/or the measured entity. Without limitation, a measurement environment or measurement equipment may also be represented by a DT to allow for virtual testing. As an alternative or in addition to having the expectation being a result of a physical measurement, the expectation may be a result of using a DT. Both may allow to obtain an expectation that limits the measurement range of the measurements to be performed within the expectation range and optionally additional tolerances but to avoid measurements in range where no results are expected. That is, the measurement range may be limited to a subset allowing a reduction of test time through use of digital twin.

Example E (Link Optimization Including Beam Management (e.g., IBM and CBM)) Examination of the digital twin allows a qualitative assessment of beam correspondence. As described, such a method may comprise examining a beam correspondence executed by the network entity, wherein the behaviour relates to a beam pattern formed with the wireless interface of a network node comprising the network entity.

### Example F (Capability Signalling Given a DT)

Diversity capabilities and/or multiplexing capabilities can be derived from digital twin.

Such a method may relate to a DT that models a diversity capability and/or a multiplexing capability of the network entity. The method may comprise to derive a capability information indicating the diversity capability and/or deriving multiplexing information indicating the multiplexing capability. The method may comprise to use at least one of the capability information and the multiplexing information for controlling communication with the network entity. That is, a communication may happen, examine and/or analyse prior, during or after communicating with regard to the capabilities of a network node or a network entity.

### Example G1 (Conformance/Performance Testing, Vendor Declaration)

The centre of radiation reference point (CORRP) is possibly no longer needed due to availability of digital twin.

### Example G2 (See Individual Bullets)

The DT of the AAU/RRU can be used in the following stages of a wireless communication system/network:
Planning and design
Commissioning
Operation (MDT)
Optimization (MDT like reporting from every network entity)
Maintenance
Expansion (contraction)
Recovery (failure recovery)
Decommissioning
Recycling/Disposal

### Example H (Non-Terrestrial Networks)

Satellites, High Altitude Platforms (HAPs), drones or other non-terrestrial entities may be represented by a DT, allowing other network entities to adapt their own behaviour (transmission/reception) incorporating knowledge about the capabilities of the other network entities in terms of desired communication or undesired interference. Furthermore, such DT allows new ways of interconnecting devices and network elements and their direct or indirect coordination of each other's behaviour (transmission/reception). Such a method may use information indicating the behaviour in view of an adaptation of a behaviour of a second entity based on the targeted behaviour of the first entity to generate a stimulus for the first entity for causing the first entity to show the targeted behaviour. Thereby, the interconnecting and/or their coordination may be adapted to one another.

Another example is the mentioned exposure of the DT to one or more networks and may be referred to example 1.

### Example I (Exposure of DT to Network(s))

a DT can be exposed to an entity in the same network or to entities belonging to other networks. This can be done in a layered approach e.g. exposing different functions or details depending on the network the other entity e.g. 3PC belongs to. A 3PC in that context could even not belong to any network, being a higher authority itself e.g. as a regulator or a spectrum watchdog.

### Example J (Encapsulation of Regulations/Rules Via DTs)

A DT can used to represent regulatory rulings e.g. spectrum emission mask, output power levels, occupied bandwidth, spurious emissions, interference levels, access rules to spectrum (LBT). Such a method may relate to a DT representing a regulatory ruling to be followed by the network entity in the wireless communication network.

Further embodiments and examples relate to real or virtual testing using a DT.

### Example K (Encapsulation of Technical Specifications/Standards or Parts of it Via DTs)

A DT can used to represent technical specification e.g. spectrum emission mask, output power levels, occupied bandwidth, spurious emissions, interference levels, access rules to spectrum (LBT), latency, protocols, message spaces.

A conformance test system suitably equipped with the means to interpret a DT of a technical specification (TS) (perhaps through the interpretation of ASN.1 code, representing a TS) can execute the required tests and measurements accordingly. In this sense it allows maximum flexibility in implementing conformance test procedures. Such a test system can read the DT of the DuT and ensure that the test environment is appropriately configured using the DT of the device and the DT of the relevant technical specification. Such a method may relate to obtain a first DT and a second DT, the second DT representing a test specification comprising a test criterion. Further, the method may comprise using a real test system or a DT thereof to combine the first DT and the second DT to determine a test result information indicating whether the network entity fulfils the technical criterion or not. The method may comprise to provide the test result information.

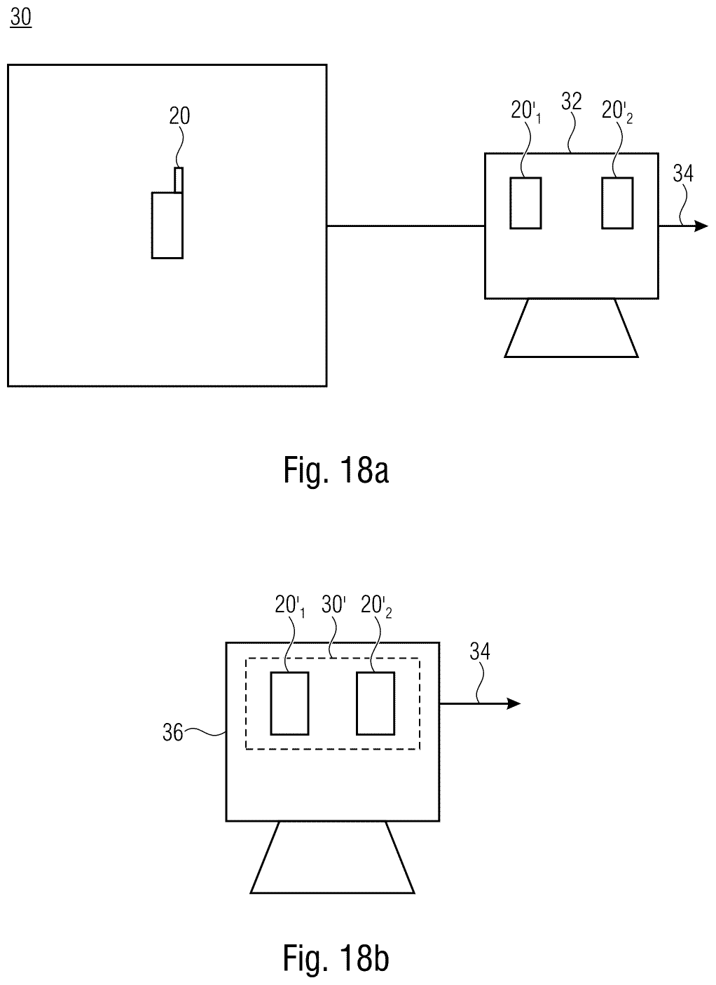

Those examples are represented in FIG. 18a and FIG. 18b. FIG. 18a shows a schematic block diagram of a test system 30 in which a DT 20′₁ of network entity 20 is used together with a DT 20′₂ representing a test specification comprising the test criterion. For example, a criterion may be one of a size, a reaction time, a delay, a transmitted power, a preciseness of a beam correspondence or any other criterion. Using the test system 30, e.g., a calculation unit 32 such as a computer or the like, the DTs 20′₁ and 20′₂ may be combined to obtain the test result information 34. The test result information 34 may indicate whether the network entity 20 fulfils the technical criterion or not. Therefore, a presence of the network entity 20 is not necessary or may be omitted as the test may also be performed by use of the DT 20′₁ thereof.

This may lead to the fact that the test system 30 itself may become optional as indicated in FIG. 18b where a calculation unit 36, e.g., the calculation unit 32 of FIG. 18a or any other apparatus for performing the respective calculations, may combine DTs 20′₁ and 20′₂ by use of a DT 30′, DT 30′ representing the test system 30 or at least a part thereof. For example, measurement conditions, a size of a measurement chamber or the free field, a position of antennas, cameras or any other sensors and/or actuators as well as their interaction among each other may be represented in the DT 30′. Thereby, a virtual test may be performed to obtain the test result information 34.

According to an embodiment, the test result information 34 may be obtained based on the DT of the real test system as a virtual test result information, i.e., the test result information 34 may rely on a virtual test. The method may further comprise to execute a physical test, e.g., using the test system 30 or a comparable test system, to test network entity 20. Alternatively, the test may be performed with an entity comparable to the network entity 20, e.g., being of a same series or having comparable components or the like. By executing the physical test, a physical test result information may be obtained. The method comprises comparing the virtual test result information with the physical test result information to obtain a comparison result. The comparison result may indicate a difference between a real test and the virtual test. Based thereon, a method may comprise to update the DT 20′₁ and/or the DT 20′₂. This allows to improve the test and to confirm the preciseness of the provided DT of the network entity 20.

Based on the comparison result, same may be used for one or more purposes. For example, it may be used to refine or update the used DT which can be used instead of the real test. Alternatively or in addition, the comparison result may be used to derive if the virtual test has at least a predetermined test quality. As a predetermined test quality it may be understood a measure, a metric, a requirement and/or a criteria whether the test or the DT is accurate enough. That is, such a method may comprise refining or updating the DT based on the comparison result; and/or determine whether a virtual test that provides the virtual test result information has at least a predetermined test quality.

A method in accordance with embodiments may comprise to qualify a virtual test that provides for the virtual test result information of FIG. 18b. This may allow to accept or reject the result and may use a metric/requirement and/or criteria. Alternatively or in addition, the method may allow to check if the virtual test provides the same result as the real test.

In accordance with embodiments, a DT may be used at or by a third party controller of the wireless communication network to control the network entity. Such a third party controller may obtain access to the control without providing the complete set of information used by the manufacturer for manufacturing the node that is more precise than a simple trial and error method and may thus allow for an open network architecture. For example, an eCPRI (enhanced common public radio interface) between the third party controller and the network entity may be used for controlling the network entity with the third party controller. Embodiments described herein may provide for methods that include to use the DT for a goal-oriented singulation of at least a part of the wireless communication network. That is, the most suitable stimulus and/or the most suitable or targeted behaviour may be selected and prior to a real control and the most suitable approach to achieve the goal may be determined prior to performing real actions. However, not only the network operation but also testing may benefit from digital twins, wherein the testing may be implemented offline or in the field. According to embodiments, a method may comprise to derive, based on the test result information described in connection with FIG. 18a and FIG. 18b at least one calibration benchmark for a calibration of the network entity.

Such a method may comprise to obtain the DT of the network entity as a first DT and to obtain a second DT that represents a technical specification comprising a performance criterion. Such a method may further comprise to combine both DTs to determine a test procedure to test whether the network entity is in accordance with the technical specification. That is, when making reference to FIG. 18a and FIG. 18b, the outcome of the test may be determined as well as the test procedure itself.

Such a determined test procedure may be subject of further examination. For example, a method may comprise to obtain a third DT that represents a measurement system, e.g., DT 30′, comprising a measurement equipment. The method may comprise to use the third DT for evaluating the test procedure whether it is feasible for the measurement system. That is, it may be examined whether the test system 30 may implement the test that is generated. Based on the result, a different test may be developed in which the outcome, i.e., to qualify the network entity 20₁ may still be performed that is within the capabilities of the test system 30.

Alternatively or in addition, a test procedure may be determined as a digital twin and may be generated to be feasible to be virtually executed by use of a digital twin representing the measurement environment, for example, under a side constraint that it is feasible to be performed therewith.

In accordance with embodiments, a method may comprise to use the DT of the network entity as a first DT and to use a second DT representing at least one object within the wired communication network, the object not communicating in the wireless communication network. Such an object may be, for example, a building, a stadium, a rock, a tree, a car, or any other object. The method may comprise to test the first DT and the second DT together for a common behaviour in a scenario that provides for stimuli for both the network node and the object. The stimuli may be any stimuli but the method may be implemented by examining certain stimuli of interest or certain stimuli, i.e., a subset from a set of available stimuli. Such a stimulating scenario may be any scenario relevant for a wireless communication network. For example, it may be of interest how the sum of the keys and, therefore, the real world, behaves in a case of a disaster, an overload scenario such as a rush hour or the like. Alternatively or in addition, a DT may be obtained that represents a measurement system comprising a measurement equipment, the method may comprise to combine the DTs to virtually execute a test procedure for testing the network entity in the measurement system.

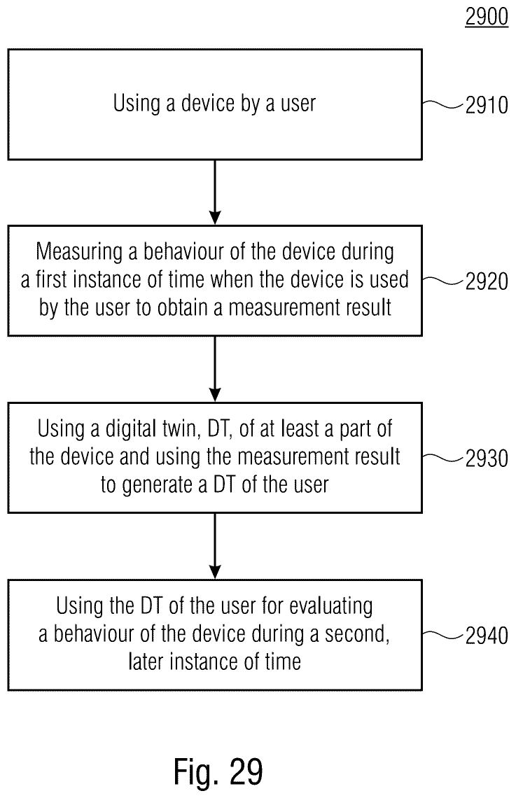

When referring again to modelling a user by a DT, a method in accordance with an embodiment that is shown in FIG. 29 by a flow chart of method 2900 that may comprise a step 2910 in which a device is used by a user. A step 2920 comprises measuring a behaviour of the device during a first instance of time when the device is used by the user to obtain a measurement result. A step 2930 comprises using a digital twin DT, of at least a part of the device and using the measurement result to generate a DT of the user. For example, it may be determined how the user has interacted with the device to obtain the measured measurement result. A step 2940 comprise to use the DT of the user for evaluating a behaviour of the device during a second, later instance of time. For example, such a method may comprise to use the DT of the user to identify of classify the user as a user using the device. Alternatively or in addition, such a method may comprise to generate a respective DT for a plurality of users and for identifying a user that uses the device based on the plurality of DTs of the plurality of users based on a measurement result of the behaviour.

Embodiments of the present invention also relate to generate a digital twin. When considering a complex structure such as a wireless communication scenario, possibly incorporating also non-communicating parts such as objects or the like, it may be of value to provide DTs for smaller parts of such a complex scenario and/or to have smaller part that may be combined to virtual complex scenarios. A method in accordance with embodiments may comprise to partition a network node or a more complex structure comprising the network entity into a plurality of partitions such that the network entity at least partially forms one partition of the plurality of partitions. The method may comprise to generate a DT for each of at least a subset of the plurality of partitions such that the DT is generated. When referring, for example, to FIGS. 6-15 or other structures such as the one illustrated in FIG. 17 or FIG. 19-23, a device or a combination of devices may also be partitioned. For example, when referring to FIG. 12a, a partitioning may relate to having a partition relating to the RU, another relating to the DU, another relating to the CU and another to the core.

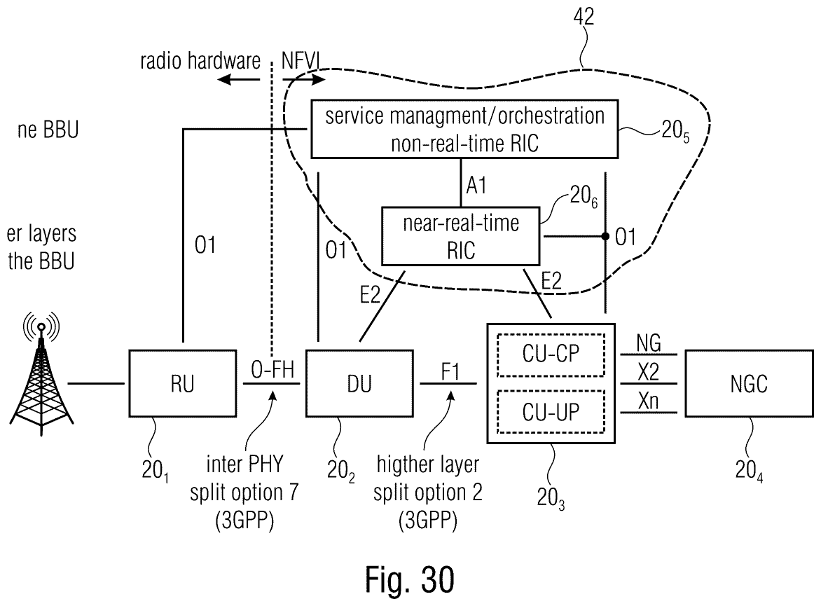

For example, when referring to FIG. 30 showing a lower section or row having network entities RU 20₁, a DU 20₂, a user plane/control plane-CU 20₃ and possibly other interfaces to other entities, such blocks may represent a network entity which may have digital twins, wherein the digital twins may be partitioned via a functionality and/or according to interfaces. One or more third party controller may be located at a controlling instance 42. The third party controller or the plurality of third party controller may be partitioned according to a real-time and non-real-time part, according to specific functionalities, according to interfaces to be used for communication or any other suitable partitioning concepts. Such concepts may refer, for example, to a priority level, to different planes or layers in a network structure or the like. The third party controller may be implemented according to a functional split/separation wherein each partition, e.g., each split part or each component, may be connected to the same or different entities and uses the same or different DTs or parts of the DTs of the same or different entities. FIG. 30 shows examples of further partitioning in the signal processing chain, e.g., the inter-PHY split option 7 (3GPP) and the Higher Layer Split Auction 2 (3GPP). Partitioning, in accordance with embodiments, may be executed together with the generation of a DT. Alternatively or in addition, the partitioning may be executed partly or completely in a supervised manner, e.g., supervised or guided or controlled by a user or the like. Alternatively or in addition, the partitioning may be executed partly or completely in an automated manner, e.g., automatically by a partitioning unit or controller unit or the like. Such a unit may comprise a calculation unit that may analyse the structure of the network node or entity and may perform the partitioning as described herein.

Starting from the idea of virtually evaluating a DT, methods in accordance with embodiments related to measuring the behaviour of the network entity and derive, e.g. by testing, by trial-and-error and/or by virtual experiments using the DT, from the measured behaviour a stimulus that causes the network entity to show, generate, produce or reproduce the measured behaviour. Measuring the behaviour of the network entity may relate to using the physical network entity or the DT. Measuring the behaviour may comprise to repeatedly stimulate the network entity, the physical version or the DT, using a sequence of stimuli and observing, for each stimulus of the sequence of the stimuli a resulting behaviour of the network entity as a response to the stimulus. Further, the method may comprise selecting, from the resulting behaviours a selected behaviour as the measured behaviour and determining the stimulus from the sequence of the stimuli that causes the network entity to show, generate, produce or reproduce the measured behaviour.

According to an embodiment, a method may comprise to generate the sequence of stimuli by determining at least a subset of the stimuli of the sequence of stimuli based on a test condition representing a predefined test of the network node such that the subset of stimuli represents stimuli of the predefined test.

According to an embodiment, the plurality of stimuli may comprise a stimulus that represents a test signal provided to the network entity during a conformance test.

### Example L (Calibration Reference Points of DTs)

If an AU/Ru is deployed in the field, but its absolute tilt, orientation etc. is not known or is uncertain the DT in combination with the specific calibration reference points e.g. a distinct antenna radiation pattern can be used to assist the device or network element in determining or reducing the uncertainty of its absolute tilt, orientation etc. The calibration reference points should be chosen completely without or with minimum ambiguity and/or uncertainty. Such a method may allow to determine a situation, e.g., an orientation, a power remaining, a tilt, a position or any other situation of the network entity by using information relating to a position and/or an orientation of measuring nodes in the wireless communication network and using measurement results provided by the measuring nodes. The measurement results may relate to the behaviour of the network entity. The method may further comprise to combine the DT with information indicating the situation. Thereby, a real test may influence the virtual DT.

### Example M (User Interaction DT)

When a user is interacting with a device e.g. holding a smartphone, certain properties can change in a way specific to the interaction of that particular user with the device. Some of these properties may be common to multiple users, whereas others may be specific to a single user. Such usage behaviour can be used to form the basis of a user interaction DT. The device can use this to determine the user without having to rely on biometric sensors such as a fingerprint reader or a camera. The DT specific to a given user's interaction with the device will allow the device to be operated in a given way, e.g. preferring or avoiding certain modes of operation e.g. selection of specific antenna panels or user functions, applications, programs, volume settings, services etc. A method in accordance with this example may comprise to generate an interaction-DT representing an interaction of a user operating the network entity or a network node comprising the network entity on the one hand and the network entity or the DT thereof on the other hand. For example, the method may comprise to generate the interaction-DT by measuring a beam/antenna/radiation pattern generated by the network entity based on the behaviour of the network entity and correlating the beam/antenna/radiation pattern with a usage, by a user, of the network node comprising the network entity. The term beam/antenna/radiation pattern relates to electromagnetic energy radiated by an antenna device and/or to a pattern defining a sensitivity thereof. However, an antenna pattern and a radiation pattern may not necessarily form a beam, e.g., when using omnidirectional antennas that are affected, however, by a presence of a user as is in the case of beamforming.

For example, a presence of a hand or head of a user may influence the radiation characteristic and/or a sensitivity of an antenna, e.g., by adding additional attenuation into the respective path.

Such a method may comprise to generate a DT of the user. Having a DT of the user may allow to identify or classify the user based on the DT of a user and based on the DT of the network entity to obtain a user information. As a user information one may understand an ID, a unique classification or a user class information. For example, a user class information may refer to a left-handed user or a right-handed user, to determine if the user is sitting or standing, whether the user is stationary or mobile or the like. A user ID may, for example, refer to identifying the user, for example, to determine whether the user is allowed to perform specific actions and/or to adapt control of the network entity, e.g., in the sense of a user profile. For example, when identifying, by use of the DT of the network entity and the use of the DT of the user that the user will handle the network entity or the respective network node with his or her left hand, the antenna radiation may be adapted correspondingly when compared to a right-handed user. That is, the method may comprise to adapt an operation of the network entity or a network node comprising the network entity based on the user information.

Example N (Inclusion of Reconfigurable Intelligent Surfaces and their Control)

The presence and/or behaviour or a RIS and/or its associated controller may be modelled and consider by other participants of the network, i.e., internal or external (third party) controllers. The behaviour of the RIS, e.g., its influence on the radio propagation may be understood and/or predicted and the RIS itself and/or other entities in the wireless communication network may be controlled accordingly to exploit the benefits provided by the RIS. Such benefits are not limited to include an improvement of link quality (e.g. SNR, reliability, latency, channel rank) between two or more entities only but may also include a reduction of the effect of interference experienced by other entities that may form part of the same network, a different network or be independent of a network.

Embodiments thus relate to use a DT of the RIS and/or the controller thereof to control e.g., using a third party controller, the RIS, e.g., directly or indirectly via the RIS controller, RISC, to exploit the benefits of a RIS.

Further embodiments are described in the following whilst making reference to the structure of network nodes and wireless communication networks, each of those components or combinations being representable by a digital twin to be used in embodiments described herein. Embodiments also relate to devices, in particular network associated devices that implement at least parts of methods described herein.

### Standardization

The 3GPP 5G RAN architecture-specified in Release 15 and known as NG-RAN-introduces new terminology, interfaces and functional modules. The NG-RAN consists of a set of radio base stations (known as gNBs) connected to the 5G core network (5GC) and to each other. The gNB incorporates three main functional modules: the centralized unit (CU), the distributed unit (DU), and the radio unit (RU), which can be deployed in multiple combinations. The primary new interface is the F1 interface between DU and CU. These are expected to be interoperable across vendors. Standardization of a further lower-layer interface between DU and RU is under consideration, but progress is likely to occur outside the 3GPP in the first instance. The CU can be further disaggregated into the CU user plane (CU-UP) and CU control plane (CU-CP), both of which connect to the DU over F1-U and F1-C interfaces respectively. This new 5G RAN architecture is described in 3GPP TS 38.401.

The following sub-sections provide further details on the RAN architecture and its components.

### Notes on RAN Architecture

As with all 3GPP standards, NG-RAN is a logical architecture that can be implemented and deployed in different ways, according to an operator's requirements and preferences. As shown to the right of FIG. 2, the base station can be deployed as a monolithic unit deployed at the cell site, as in classic cellular networks, or split between the CU, DU and RU. The CU-DU interface is a higher-layer split (HLS), which is more tolerant to delay. The DU-RU interface is a lower-layer split (LLS), which is more latency-sensitive and demanding on bandwidth, but may offer improved radio performance across a coverage area due to coordination gain. CUs, DUs and Rus can be deployed at locations such as cell sites (including towers, rooftops and associated cabinets and shelters), transport aggregation sites and “edge sites” (e.g., central offices or local exchange sites).

In the following, examples are explained that may form at least a part of a network entity in accordance with embodiments.

### Radio Unit

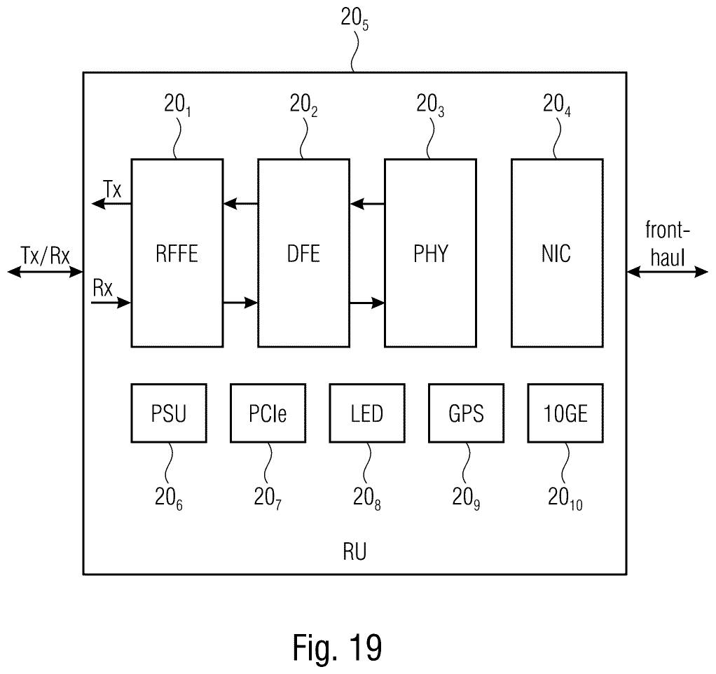

The RU (or alternatively, the remote radio unit (RRU)) handles the digital front-end (DFE) and the parts of the PHY layer, as well as the digital beamforming functionality. 5G RU designs are supposed to be “inherently” intelligent, but the key considerations of RU design are size, weight, and power consumption. A block diagram of an RU is shown in FIG. 19 and is comprised of: a radio frequency front-end unit (RFFE); a digital front-end unit (DFE); a physical layer translator (PHY); a network interface connection (NIC) and; a power-supply unit (PSB). In addition, the RU might comprise of ancillary functions not limited to include: a peripheral component interconnect express (PCIe) interface; a global positioning system (GPS); a 10 gigabit Ethernet (10GE) interface); and light emitting diodes (LEDs).

FIG. 19 shows an example a radio unit (RU) comprised of various functional blocks. The radio frequency connection (Tx/Rx) to the antenna unit and the fronthaul connection to the distributed unit are shown.

### Distributed Unit

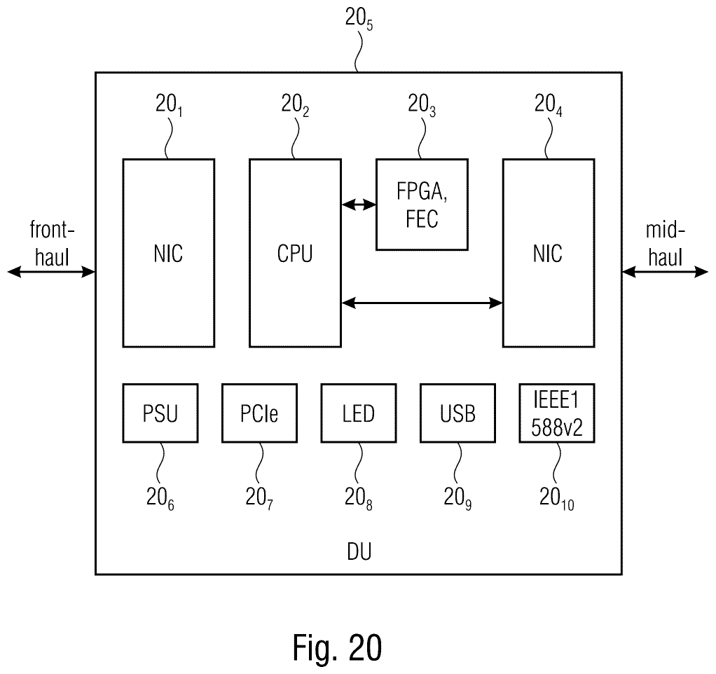

The DU sits close to the RU and runs the radio link controller (RLC), medium access control (MAC), and parts of the physical (PHY) layer. This logical node includes a subset of the eNB/gNB functions, depending on the functional split option, and its operation is controlled by the CU. A block diagram of a DU is shown in FIG. 20 and comprises the following functions: NIC; central processing unit (CPU); floating-point gate array (FPGA); forward error correction (FEC) and; a power-supply unit. In addition, the DU might comprise ancillary functions not limited to include: a PCIe interface; a universal serial bus (USB) interface; precision clock (IEEE1588v2) and; LEDs.

FIG. 20 shows an example of a distributed unit (DU) comprised of various functional blocks-see text for description. The fronthaul connection to the radio unit and the midhaul connection to the centralized unit are shown.

### Centralized Unit

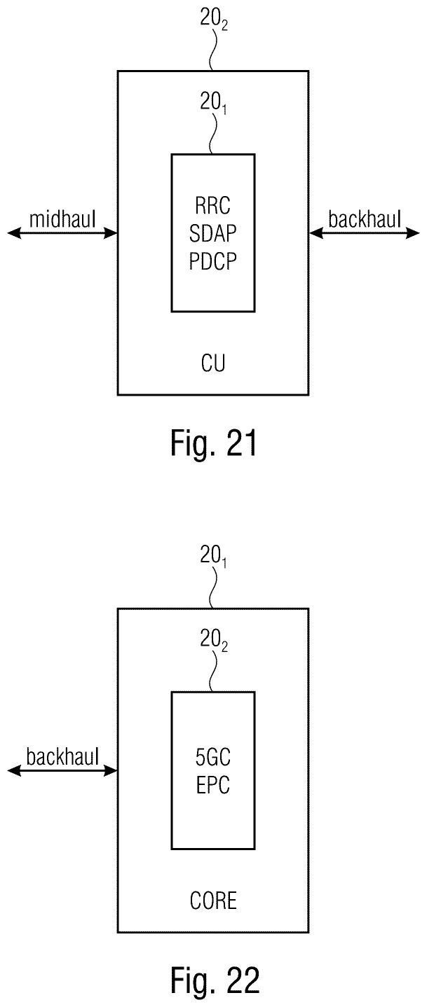

The CU runs the radio resource control (RRC), the service data application protocol (SDAP) and the packet data convergence protocol (PDCP) layers. The gNB consists of a CU and one DU connected to the CU via Fs-C and Fs-U interfaces for control plane (CP) and user plane (UP) respectively. A CU with multiple DUs will support multiple gNBs. The split architecture enables a 5G network to utilize different distribution of protocol stacks between CU and DUs depending on midhaul availability and network design. It is a logical node that includes the gNB functions such as the transfer of user data, mobility control, RAN sharing (MORAN), positioning, session management etc., with the exception of functions that are allocated exclusively to the DU. The CU controls the operation of several DUs over the midhaul interface. FIG. 21 shows a block diagram of a CU containing the functions of RRC, SDAP and PDCP. That is, an example of a centralized unit (CU) comprised of various functional blocks-see text for description. The midhaul connection to the distributed unit and the backhaul connection to the core unit are shown.

### The Core

Depending on how service providers deploy their radio networks and the technology they use for coverage and capacity bands, they may end up with different core network solutions. Compared to the evolved packet core (EPC) which was first used in 4G LTE networks, the major difference with the 5G core (5GC) is that the latter's control plane (CP) functions interact in a service-based architecture (SBA). A key network function (NF) of SBA is the network repository function (NRF) which provides NF service registration and discovery, enabling NFs to identify appropriate services in one another. SBA principles apply to interfaces between CP functions within 5GC only, so interfaces toward the RAN, user equipment or user plane (UP) functions (N1, N2, N3, N4, N6 and N9) are excluded.

Another major difference in 5GC's CP is its structure which separates access and mobility functions (AMF) and session management functions (SMF). 5GC includes the separation of UP and CP functions of the gateway, which was an evolution of the gateway CP/UP separation (CUPS) introduced in EPC Release 14. Other changes include a separate Authentication Server (AUSF) and several new functions, such as the Network Slice Selection Function (NSSF) and the Network Exposure Function (NEF). In FIG. 22 an example of a core unit (CORE) comprised of various functional blocks-see text for description. The backhaul connection to the centralized unit is shown.

### Combining the Units

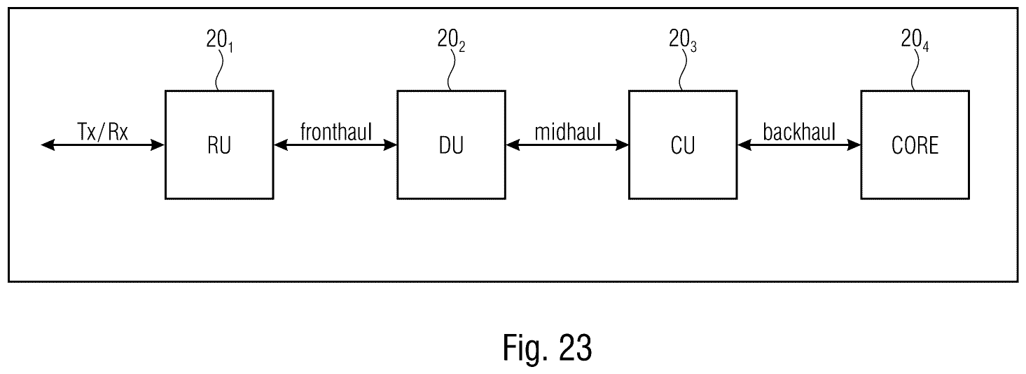

A simplified interconnection diagram that shows the RU, DU, CU and CORE units and their interfaces is presented in FIG. 23 showing a functional block diagram showing the arrangement and connection of radio unit (RU), distributed unit (DU), centralized unit (CU) and core using fronthaul, midhaul and backhaul interfaces, respectively. The radio frequency interface (Tx/Rx) is also shown even its connection to the antenna unit (AU) has been removed for convenience.

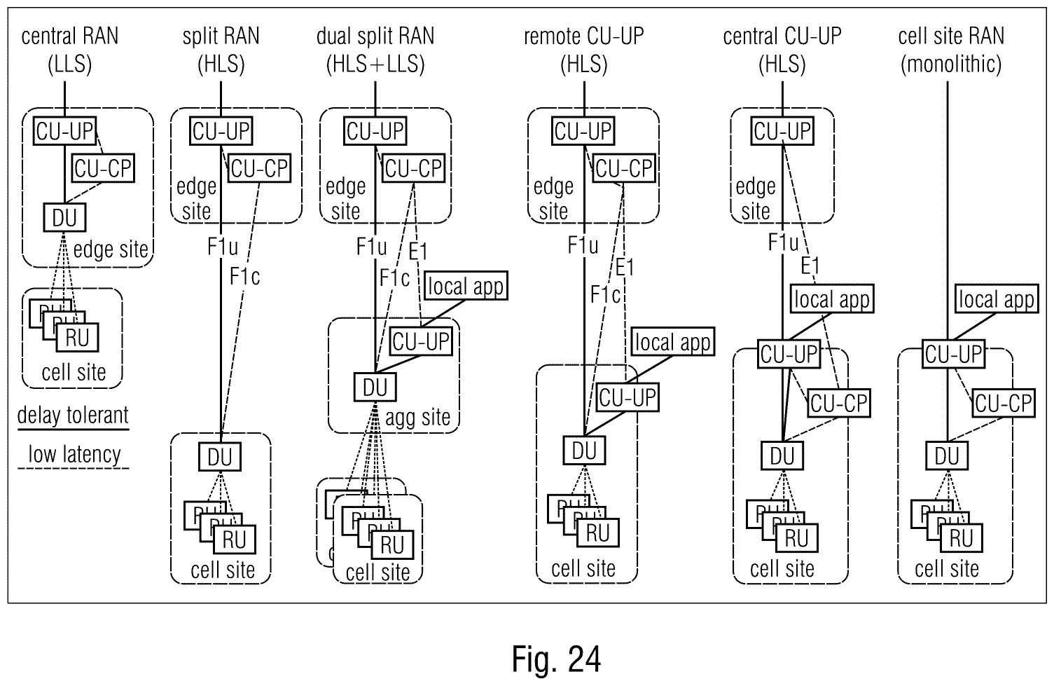

Based on the simplified arrangement shown above, other topologies are possible including those examples shown in FIG. 24. A Location Flexibility for 5G RAN Functional Units After NGMN is shown. In addition to the interfaces discussed previously, this figure also shows those connections which can either be categorized as delay tolerant or as a low latency.

### Management Interfaces and Miscellaneous

The Element Management System (EMS) of the 5G Open RAN system shall provide interfaces that comply with 3GPP Integration Reference Points (IRP) specifications. The EMS shall provide management, configuration, monitoring, optimization and troubleshooting capabilities. The interface of 5G Open RAN NR for the management shall be an IP based interface that supports management protocols such as NETCONF, YANG model etc. For the management of the fronthaul interface between RU and DU, it shall comply with the O-RANWG4 published management plane specifications. It shall be integrated with the EMS system.

### The Antenna Unit

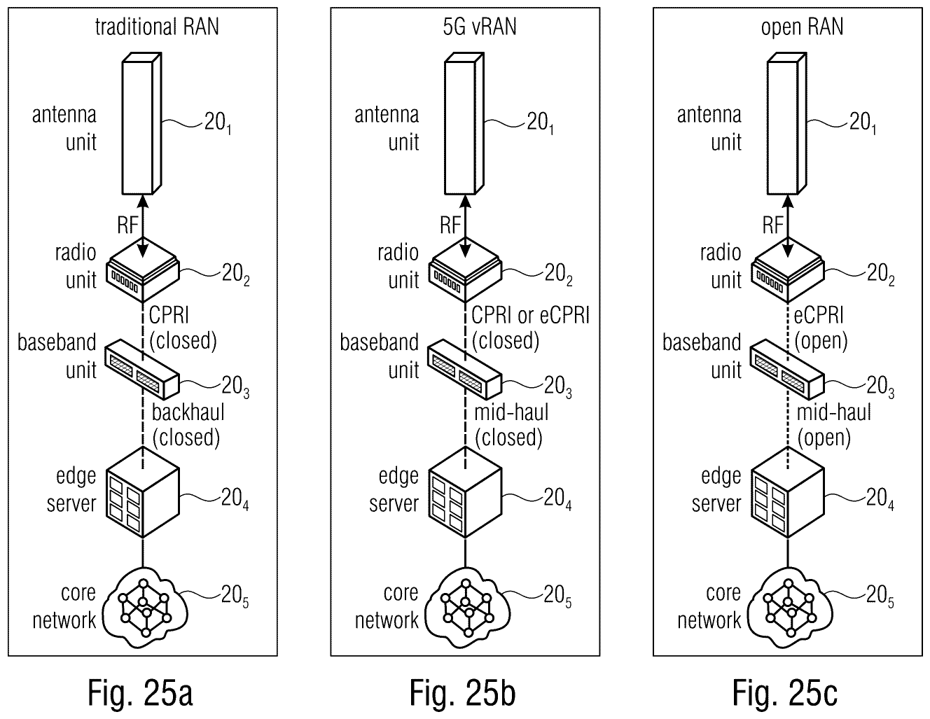

Thus far, the discussion of RAN architecture has described the RU, DU, CU and CORE units only. To provide a broader and alternative view, FIG. 25 shows traditional RAN, 5G vRAN and Open RAN architectures in which the DU and CU are labelled as baseband unit and edge server respectively. The figure also shows that the radio unit is connected to an antenna unit (AU) and therefore, in many cases at least, the AU and RU are separate pieces of equipment. Further to the brief introduction of the AU given herein, it should be noted the interface between the RU and AU comprised a cabled radio frequency (RF) connection for simple passive base station antennas. However, active base station antennas that implement some form of beam forming functionality will, in addition to the RF connection, require some form of control connection. In FIG. 25 from left to right there is shown in FIG. 25a a traditional RAN architecture comprising proprietary hardware and software provided by a single vendor; in FIG. 25b a 5G virtual RAN consisting of off-the-shelf hardware. The proprietary interfaces and software are provided by a single vendor; and in FIG. 25 can Open RAN containing off-the-shelf hardware, open interfaces and proprietary software provided by multiple vendors.

### Reconfigurable Intelligent Surfaces

A RIS allows for reconfiguring a propagation environment and allows enhancing the quality of signal reception. Thereby a coverage area, an energy efficiency, a reliability, a channel rank and/or data rates may be enhanced. Compared with conventional systems, it may be implemented without additional power supply, complex encoding or decoding operation to enhance the system's performance, e.g., when utilising a large number of small, possibly low-cost and passive reflecting elements to effectively control the propagation characteristics of the desired incident signal through the adjustable amplitude and phase shift of each reflecting element without signal processing. A RIS further allows the effects of interference experienced by users to be mitigated and is not limited to the propagation environment in which enhanced quality of signal reception can be obtained but may also be of benefit to users of different propagation channels. For example, a terrestrial network (TN) comprised of passive and/or active antenna systems, reconfigurable intelligent surfaces, other wireless equipment and suitable controllers (i.e. 3PCs and RISCs) may be arranged to improve the quality of the TN and/or a non-terrestrial network (NTN) such as one provided by unmanned airborne vehicles (UAVs), high-altitude platforms (HAPs), geostationary orbiting (GSO) and non-geostationary orbiting (NGSO) satellites.

### Further Notes

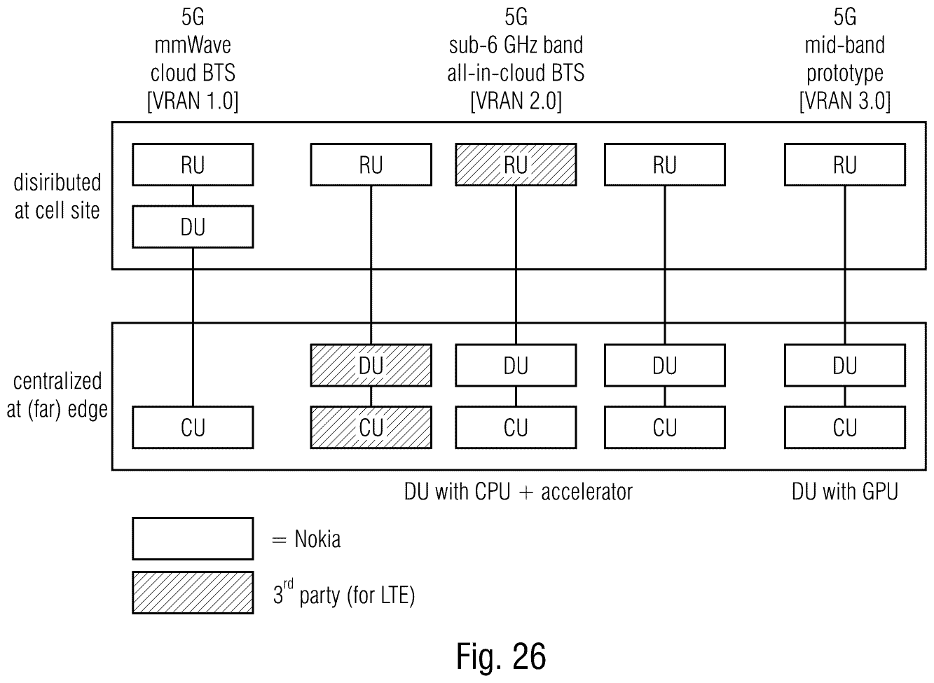

Previous RAN architectures (2G, 3G and 4G) were based on “monolithic” building blocks, where few interactions happened between logical nodes. Since the earliest phases of the new radio (NR) study, however, it was felt that splitting up the gNB (the NR logical node) between central units (CUs) and distributed units (Dus) would bring flexibility. Flexible hardware and software implementations allow scalable, cost-effective network deployments—but only if hardware and software components are inter-operable and can be mixed and matched from different vendors. A split architecture (between central and distributed units) allows for coordination for performance features, load management, real-time performance optimization and enables adaptation to various use cases and the QoS that needs to be supported (i.e. gaming, voice, video), which have variable latency tolerance and dependency on transport and different deployment scenarios, like rural or urban, that have different access to transport like fibre. But what makes any split architecture open and suited for Open RAN? A mobile operator can deploy a fully compliant functional split architecture, but unless the interfaces between RU, DU and CU are open, the RAN itself will not be open. FIG. 26 presents an example of commercial deployment examples of Open RAN and Virtual RAN architectures.

While the diagram above shows current industry thinking, some OEMs believe that the only valid split is between RU and DU. In summary, RAN functional splits will bring cost savings if interfaces between hardware and software components are open. In other words, and with specific application to the invention disclosed herein, regardless of how operators choose to partition their network topologies, the cost saving benefits offered by multi-vendor equipment procurement can only be obtained through the use of open interfaces and those that are not proprietary to any given OEM. The current invention not only exploits this fact but also builds upon it by using a digital twin to continue information necessary for the efficient and effective interoperation of equipment and other network entities.

### The Digital Twin

A digital twin is the generation or collection of digital data representing a physical object. The concept of digital twin has its roots in engineering and the creation of engineering drawings/graphics. Digital Twins are the outcome of continuous improvement in the creation of product design and engineering activities.

In the context of a wireless communication system (WCS), a digital twin can be used to describe or represent any entity used in the WCS not limited to include the following examples: a base station (BTS); a BTS antenna; a user equipment (UE); a UE antenna; an access node; a backhaul node; an integrated access and backhaul (IAB) device; an IAB antenna; a network comprised of one or more of the aforementioned network entities.

One aspect of a digital twin can be thought of, in some ways, as being similar to a datasheet. However, the digital twin (of a product) offers several advantages over a datasheet: the content is structured, machine readable, electronically transferrable and can contain as much or as little data as required for a particular purpose—in other words, a digital twin can inherit limited information from a parent. Beyond the concept of the extended datasheet, the digital twin offers many additional advantages. For example, when considering the digital twin of an antenna system, and whereas a datasheet might provide tables or graphs that present return loss, gain, cross-polarization discrimination, port-to-port isolation and so on-all as a function of the operating frequency—the digital twin can provide performance information that is a function of multiple parameters, perhaps being a combination of independent and dependent operational and/or performance variables such as temperature, power level, frequency, bandwidth, steering angle, number of beams and so on. The plethora of such data could easily exceed the practical limitations of a datasheet especially when considering multiple and dynamic inputs that require simultaneous combination.

The information contained within a digital twin can be used at different times and for different purposes during the development, design, construction, testing, commissioning, operation and optimization of a WCS. Furthermore, the same information can be provided to a second WCS such that the one or more WCSs cooperate or collaborate in order to achieve a desired level of performance and/or provide a required quality of service.

As an example of a digital twin, consider a base station antenna. This can be described by a collection of physical parameters, both mechanical and electrical. In the latter category, the digital twin is not limited to include a description of its: operating frequency range; gain; antenna radiation pattern per se; antenna driving port impedance the port-to-port coupling or isolation; the maximum acceptable transmit power; a passive intermodulation (PIM) distortion metric. Any or all of the preceding descriptions can also include measurements made over frequency, for different polarizations and in the case of a multiport antenna for different ports.

An overview of the concepts associated with the digital twin are presented in the following sub-sections.

### Operation of a Digital Twin

A digital twin is a virtual representation of a physical product or process, used to understand and predict the physical counterpart's performance characteristics. Digital twins are used throughout the product lifecycle to simulate, predict, and optimize the product and production system before investing in physical prototypes and assets.

By incorporating multi-physics simulation, data analytics, and machine learning capabilities, digital twins are able to demonstrate the impact of design changes, usage scenarios, environmental conditions, and other endless variables—eliminating the need for physical prototypes, reducing development time, and improving quality of the finalized product or process.

To ensure accurate modelling over the entire lifetime of a product or its production, digital twins use data from sensors installed on physical objects to determine the objects' real-time performance, operating conditions, and changes over time. Using this data, the digital twin evolves and continuously updates to reflect any change to the physical counterpart throughout the product lifecycle, creating a closed-loop of feedback in a virtual environment that enables companies to continuously optimize their products, production, and performance at minimal cost.

Digital Twins Vs. Simulations

Although simulations and digital twins both utilize digital models to replicate a system's various processes, a digital twin is actually a virtual environment, which makes it considerably richer for study. The difference between digital twin and simulation is largely a matter of scale: while a simulation typically studies one particular process, a digital twin can itself run any number of useful simulations in order to study multiple processes.

The differences do not end there. For example, simulations usually do not benefit from having real-time data. But digital twins are designed around a two-way flow of information that first occurs when object sensors provide relevant data to the system processor and then happens again when insights created by the processor are shared back with the original source object.

By having better and constantly updated data related to a wide range of areas, combined with the added computing power that accompanies a virtual environment, digital twins are able to study more issues from far more vantage points than standard simulations can—with greater ultimate potential to improve products and processes.

### Types of Digital Twins

There are various types of digital twins depending on the level of product magnification. The biggest difference between these twins is the area of application. It is common to have different types of digital twins co-exist within a system or process. Let us go through the types of digital twins to learn the differences and how they are applied.

### Component Twins/Parts Twins

Component twins are the basic unit of digital twin, the smallest example of a functioning component. Parts twins are roughly the same thing, but pertain to components of slightly less importance.

### Asset Twins

When two or more components work together, they form what is known as an asset. Asset twins let you study the interaction of those components, creating a wealth of performance data that can be processed and then turned into actionable insights.

### System or Unit Twins

The next level of magnification involves system or unit twins, which enable you to see how different assets come together to form an entire functioning system. System twins provide visibility regarding the interaction of assets and may suggest performance enhancements.

### Process Twins

Process twins, the macro level of magnification, reveal how systems work together to create an entire production facility. Are those systems all synchronized to operate at peak efficiency, or will delays in one system affect others? Process twins can help determine the precise timing schemes that ultimately influence overall effectiveness.

### Alternative/Additional Categories of Digital Twins

In addition to the categories discussed above, digital twins can be grouped according to the stage of the product lifecycle it models—product, production and performance. These are explained below. The combination and integration of these three digital twins as they evolve together is known as the digital thread. The term “thread” is used because it is woven into, and brings together data from, all stages of the product and production lifecycles.

### Product Digital Twin

Digital twins can be used to virtually validate product performance, while also showing how your products are currently acting in the physical world. This “product digital twin” provides a virtual-physical connection that lets you analyses how a product performs under various conditions and make adjustments in the virtual world to ensure that the next physical product will perform exactly as planned in the field. It doesn't matter if you have complex systems and materials—product digital twins help you navigate that complexity to make the best possible decisions. All of this eliminates the need for multiple prototypes, reduces total development time, improves quality of the final manufactured product, and enables faster iterations in response to customer feedback.

### Production Digital Twin

A production digital twin can help validate how well a manufacturing process will work on the shop floor before anything actually goes into production. By simulating the process using a digital twin and analysing why things are happening using the digital thread, companies can create a production methodology that stays efficient under a variety of conditions. The production can be optimized even further by creating product digital twins of all the manufacturing equipment. Using the data from the product and production digital twins, businesses can prevent costly downtime to equipment—and even predict when preventative maintenance will be necessary. This constant stream of accurate information enables manufacturing operations that are faster, more efficient, and more reliable.

### Performance Digital Twin

Smart products and smart plants generate massive amounts of data regarding their utilization and effectiveness. The performance digital twin captures this data from products and plants in operation and analyses it to provide actionable insight for informed decision making. By leveraging performance digital twins, companies can:
Create new business opportunities
Gain insight to improve virtual models
Capture, aggregate, and analyses operational data
Improve product and production system efficiency

In the context of a WCS, a performance digital twin can be used to store operational data that is related to the performance of a device collected during the various stages of its life-cycle not limited to include: manufacturing; testing; deployment; commissioning; operation; optimization; maintenance; decommissioning; and disposal. For example, a suitably equipped radio unit—with or without an associated antenna unit—might have the means to measure parameters related to its performance such as: spurious emissions; intermodulation performance; transmit power level stability; and so on. Such measures could be determined as a function of operating frequency, assigned bandwidth, power class, modulation scheme etcetera.

### Market Forecasts

The digital twin market was valued at USD 3.1 billion in 2020 and is expected to reach USD 48.2 billion by 2026, at a CAGR of 58% from 2020 to 2026. Increasing demand for digital twins in the healthcare and pharmaceutical industries due to the outbreak of COVID-19 pandemic, the changing face of maintenance, and growing adoption of digital twin solutions to cope up with the COVID-19 pandemic are the key factors driving the growth of the digital twin market.

The system digital twin is expected to account for the largest share of the digital twin market. This growth can be attributed to the increasing use of digital twin for systems in various applications. For example, in the aerospace and defence sector, the low-cost manufacturing and assembly of composite and hybrid structures (LOCOMACHS) has implemented a digital twin for the entire assembly line for an aircraft wing for performance monitoring.

The automotive and transportation industry accounted for the largest market share in the digital twin market in 2019 which is attributed to the increasing usage of digital twins for designing, simulation, maintenance-repair-and-overhaul (MRO), production and after service. It is predicted that this is one of a number industry sectors that will witness high growth in the post-COVID-19 period, as industrials will try to adopt digital solutions for their end-to-end operations to minimize the losses that have occurred due to the pandemic.

In recent years, the development of various software and deployment of automation solutions in the manufacturing industries has improved production lines and downstream operations. These developments have positively impacted the growth of the digital twin market in North America due to the high economic growth and a large presence of vendors offering digital twins.

### Model-Based Systems Engineerinq

Due to the increased complexity of engineering processes and products alike, model-based approaches have become common place wherein a model is an abstraction of a real system within its operational environment. While such models can be used for both analysis and specification purposes, they can also be used by different parties such as manufacturer and customer. While there are many different types of system modelling languages available, the best-known example is the unified modelling language (UML) which allows modelling and documentation of object-oriented systems in a standardized syntax.

The Model-Based Systems Engineering (MBSE) approach leads away from a documents-based development to a model-based one. MBSE is a method and tool for systems engineering. When applied correctly, it supports systems design and combines best practices of traditional systems engineering with powerful virtual modelling techniques.

When applied to the engineering process of designing a base station antenna, the MBSE-based antenna is developed using models comprising individual parts of the antenna, their electrical performance and the operational environment. This allows the antenna to be modelled throughout the whole product lifecycle.

### Platform Independent Code

The concept of a digital twin is now considered in the context of a computer programming language or code and, in particular, one that is independent of the platform on which it is used. To introduce this discussion, certain keywords are defined based on the widely-deployed and popular JAVA as follows.

Platform: Any hardware or software environment in which a program runs, is known as a platform. For example, since Java has its own run-time environment—JAVA run-time environment (JRE)—and application programming interface (API), it is called platform.

Platform independent: Unlike many other programming languages including C and C++, when Java is compiled, it is not compiled into platform specific machine code, rather into platform independent byte code. The byte code can be distributed over the Internet and then interpreted by a Java virtual machine (JVM) running on any particular platform.

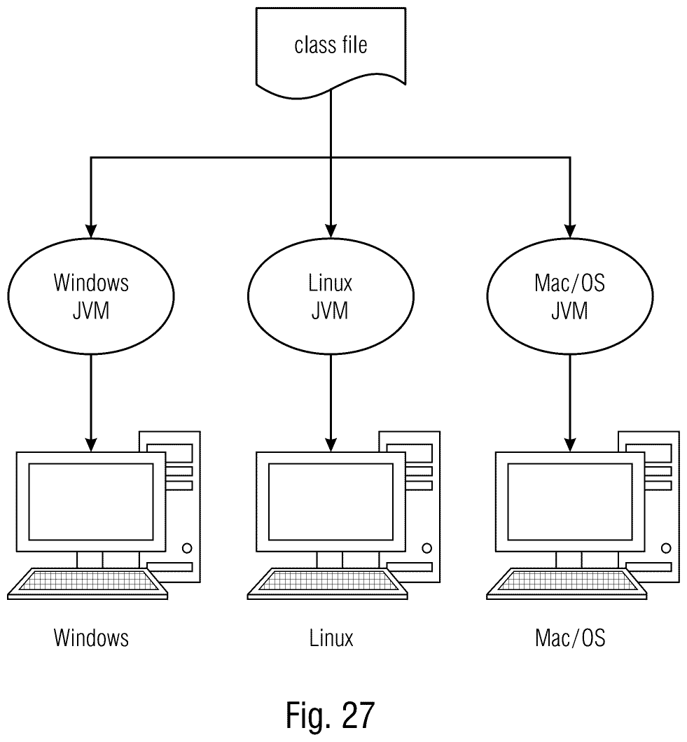

Platform independence in Java offers the advantage of “write once, run anywhere” (WORA). In other words, Java code can be run in any operating system that supports Java without recompilation—see for example FIG. 27 illustrating an example showing the platform independence of Java and the manner in which the same class file and be executed on a variety of machines running different operating systems. Currently, Java Standard Edition programs can run on Microsoft Windows, Mac OS X, several UNIX-like operating systems and several more non-UNIX-like operating systems such as embedded systems. For mobile applications, browser plugins are used for Windows and Mac based devices, and Android has built-in support for Java.

Java applications are typically compiled to bytecode that can run on any Java Virtual Machine (JVM) regardless of computer architecture.

Java code running in the JVM has access to OS-related services, like disk 1/O and network access, if the appropriate privileges are granted. The JVM makes the system calls on behalf of the Java application. This setup allows users to decide the appropriate protection level, depending on an ACL. For example, disk and network access is usually enabled for desktop applications, but not for browser-based applets. JNI can also be used to enable access to operating systems specific functions.

### Platform Dependent Code

In contrast to platform independent code, this sub-section presents MATLAB MEX-files as an example of a platform dependent code. A MATLAB executable (MEX) file is a function, created in MATLAB, that calls a C/C++ program or a Fortran subroutine. A MEX function behaves just like a MATLAB script or function. To call a MEX function from within MATLAB, the name of the MEX file (without the file extension) is used. The MEX file itself contains only one function or subroutine and the calling syntax depends on the input and output arguments defined by the MEX function. Now while MATLAB scripts and functions have platform-independent extensions .m and .mlx, MEX functions have these 64-bit platform-specific file extensions:
Linux®—.mexa64
Apple macOS—.mexmaci64
Microsoft® Windows®—.mexw64

It should be noted that although MATLAB functions and scripts (m-files) are plain text files which are platform independent, MATLAB executable code itself is platform dependent and different operating systems (OS) require their own OS specific version of MATLAB to be installed. This is also true to a certain extent for programming languages such as C, C++, Fortran and Python.

Those examples relating to a platform independent code are used to illustrate the advantages to have a digital twin to be operated, e.g., at a third party controller, i.e., at a controller provided by a different manufacturer, entity or authority when compared to the controlled module. By formulating the device as a digital twin and as a device providing a behaviour responsive to a stimulus, a specific code structure or a specific language may be become of less relevance.

### An Electronic Digital Twin

According to embodiments one or more types of DT may be used
Model based DT using mathematical functions and descriptions to describe/represent physical entities, properties, behaviour etc.
Derived from ML/AI whereby the mapping of inputs to outputs is known for certain conditions.
The derived DT allows DTs to be obtained/used for physical entities that were not designed with a DT in mind (a posteriori derivation of a DT or an existing physical apparatus)

### Types of SIM

Single-use SIM: One time authentication used when commissioning a remote radio unit. The details held on the SIM are uploaded and after verification (by the appropriate network authority), the SIM is activated/deactivated and its contents either locked or deleted.
eSIM. Connects a Radio Unit to one or more Baseband Units and one or more Core Networks (MNOs) for:
   RAN, BBU and RRU sharing
   ASA, LSA and NR-U

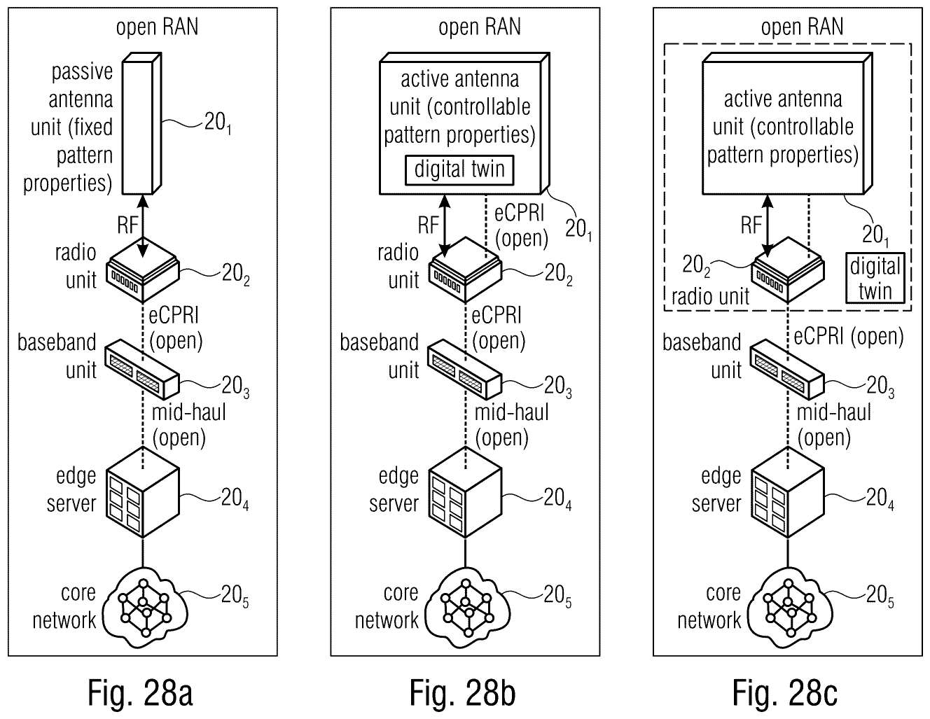

With reference FIG. 25a-c, an Open RAN architecture containing off-the-shelf hardware, open interfaces and proprietary software provided by multiple vendors is shown in FIG. 28a-c. From left to right: In FIG. 28a a passive AU is connected via an RF connection to the RU. In FIG. 28b an active AU is connected to the RU via both an RF and an open eCPRI connection. In FIG. 28c an active antenna unit (AAU), thus allowing its pattern properties to be controlled via an open interface such as the eCPRI shown. Embedded within the AAU is its digital twin.

Embodiments described herein relate to generating a DT to determine a behaviour responsive to a stimulus. However, embodiments are not limited hereto. Embodiments also relate to generate an inverse DT, e.g., from measurements and/or from the DT, the inversed DT projecting the behaviour of the networked entity into at least one stimulus causing the behaviour. The inverse digital twin may therefore be understood in an opposing or reverse direction of the DT modelling the behaviour responsive to a stimulus. Embodiments may relate to use the DT of the network entity to derive a stimulus to the network entity resulting in the targeted behaviour of the network entity. The stimulus may be part of a set of stimuli, the set of stimuli comprising a plurality of stimuli originated in at least one entity. The set of stimuli may case the targeted behaviour and the method may comprise to derive the set of stimuli and for generating the set of stimuli to cause the targeted behaviour.

In DTs described herein may relate to one of a component digital twin, an asset digital twin, a system digital twin, a processed digital twin, a product digital twin, a production digital twin, a performance digital twin, a conformance digital twin, e.g., according to a requirement, conformance testing, e.g., with regard to different regions or countries or the like. Embodiments also relate to combinations thereof.

Further embodiments relate to an apparatus, e.g., a network entity, a controller such as a third party controller or a network node being configured for implementing a method as described herein. Alternatively or in addition, a wireless communication network is part of embodiments, the wireless communication network being configured for implementing a method according to embodiments described herein.

Another embodiment is described in connection with FIG. 31 showing a wireless communication scenario 320. Therein, a plurality of objects 52₁ to 52₄ are located, e.g., in buildings or the like. Whilst it has already been described that such objects 52₁ to 52₄ may also be at least a part of a digital twin and to be considered in more complex scenarios, to the objects 52₁ to 52₄ a reconfigurable intelligent surface 54₁, 54₂, 54₃ and/or 54₄ may be attached. The reconfigurable surface may also be represented as a digital twin thereof or may be included in a more complex digital twin. Reconfigurable intelligent surfaces (RIS) may allow to reconfigure paths so as to compensate for a blocked direct link 48_{B} by providing a non-line of sight path 56_{R} by controlling the reconfigurable surface 54₁ so as to redirect the path 56_{R} towards a mobile terminal 64₁ that suffers from the blockage of blocked link 58_{B}. However, multiple other scenarios for a use of an RIS may be present. For example, a link 58_{S} that suffers from experiences interference caused by an interfering link 58₁ of a different mobile terminal 64₂ may be changed to a link 62_{R} that is less effected or possibly unaffected from link 58₁. Therefore, RIS and the digital twins thereof may be part of an interference interfering whilst link 56_{R} may be part of a signal engineering.

Alternatively or in addition, RIS may also be part of a security engineering. For example, a path 56_{A} to be avoided may be blocked or attenuated by use of RIS 54₃ to direct a data stream 66 towards terminal 64₁ and by avoiding a reflection towards an eavesdropper or the like at the same time. Alternatively or in addition and as illustrated for RIS 54₄ such structures may be part of a scattering engineering to provide for MIMO low-scattering channels i.e. channels having a low rank, together with MIMO rich-scattering channels i.e. channels have a high rank, and a multipath propagation through the network by having two or more multipath components 68₁ and 68₂ to arrive at terminal 64₃.

In other words, a reconfigurable intelligent surface can be used as a passive yet configurable network entity. Electrical control of the RIS allows its characteristic to be changed such that the refection of an electromagnetic (EM) wave incident on the surface may be pointed, focused or dispersed in a certain direction. Similarly, a RIS may affect the transfer of an EM wave that is transferred through the surface rather than being reflected from it. Embodiments allow therefore for the propagation of waves into and out of buildings through for e.g. windows, cladding and/or other building materials.

FIG. 31 illustrates four scenarios, each of which provides a specific example of how the RIS can be used in a wireless communication system (WCS) wherein a RIS is mounted or fixed to an object, typically one that is immovable such as a building or other fixed structures. A RIS may be controlled by use of a method and/or through an apparatus in order to provide the required WCS enhancement such as coverage improvement, interference management, security strengthening or an increase in the channel rank. Such RIS may be controlled by one or more controllers, i.e., a device, apparatus or a function that forms part of the WCS. Those controllers may use a DT of the RIS to obtain knowledge about its behaviour. In view of this, a digital twin of a RIS may be used in order that the WCS may determine how to control and configure the RIS such that certain performance and requirement objectives, (i.e. a behaviour) are met. Without limitation, further or additional embodiments allow for a digital twin of the RIS controller. That is, the entity modelled by a DT may be the RIS itself and/or a controller that controls the RIS.

Embodiments allow to facilitate the interoperation of equipment using interfaces. A digital twin contains a set of information that describes the properties of the device. In other words, the digital twin may be a description of the physical twin, the device or equipment itself, and may, thus, include electrical, mechanical, chemical, physical, optical, acoustical, biological, and/or environmental parameters and/or descriptors. This information may be provided over the defined interfaces, e.g., an open RAN interface, thus enabling other devices and equipment to configure themselves accordingly.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### ABBREVIATIONS

| | | Further |
|---|---|---|
| Abbreviation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP | control plane | |
| CP1 | control plane 1 | |
| CP2 | control plane 2 | |
| CPRI | common public radio interface | |
| CSI-RS | channel state information reference | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LTE | long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA |
| NG-RAN | either a gNB or an NG-eNB | |
| NGSO | non-geostationary orbit | |
| NIC | network interface connection | |
| NR | new radio | |
| NR-U | NR unlicensed | NR operating |
| | | in unlicensed |
| NTN | non-terrestrial network | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known |
| | | as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TDD | time division duplex | |
| TN | terrestrial network | |
| TSG | technical specification group | |
| UAV | unmanned airborne vehicle | |
| UE | user equipment | |
| UL | uplink | |
| UP | user plane | |
| URLLC | ultra-reliable low latency communication | |
| UTRAN | universal trunked radio access network | |
| V2X | vehicle-to-everything | |
| VoIP | voice over internet protocol | |
| vRAN | virtual ran | |
| WI | work item | |
| WLAN | wireless local area network | |

1-71. (canceled)

72. A method for operating a wireless communication network comprising at least two network nodes that each include a wireless interface for wireless communication, the at least two network nodes including a plurality of network entities, wherein the method comprises at least one of:
using a digital twin (“DT”) of a network entity of the plurality of network entities to derive a behaviour of the network entity, the behaviour being based on a stimulus to the network entity; and
using the DT of the network entity to derive a stimulus to the network entity resulting in a targeted behaviour of the network entity.

73. The method according to claim 72, further comprising:
controlling the network entity based on the DT,
wherein the stimulus is an input to the network entity; and
wherein the behaviour is a reaction of the network entity based on the stimulus and relates to a beam pattern formed with a wireless interface of a network node comprising the network entity.

74. The method of claim 72, further comprising deriving, by the DT, the behaviour of the network entity that is based on the stimulus to the network entity,
wherein:
the DT models or represents the network entity being a first network entity and is used by a second network entity of the plurality of network entities to determine information indicating the behaviour of the first entity, the method comprising using the information indicating the behaviour of the first entity, or
the DT models the network entity and is used by the network entity to determine information indicating the behaviour of the entity, the method comprising using the information indicating the behaviour.

75. The method of claim 74, further comprising:
modelling or representing, by the DT, the network entity being a first network entity that is used by the second network entity of the plurality of network entities to determine information indicating the behaviour of the first entity as a targeted behaviour; and
using the information indicating the behaviour of the first entity, such that using the information indicating the behaviour comprises an adaptation of a behaviour of the second entity based on the targeted behaviour of the first entity to generate a stimulus for the first entity for causing the first entity to show the targeted behaviour.

76. The method of claim 75, wherein at least one of:
the adaption of the behaviour relates to a transmission and/or reception behaviour based on interference experienced by at least one of the first entity and the second entity, and the DT of the network entity is used to derive a stimulus to the network entity resulting in a targeted behaviour of the network entity, such that at least one of:
the DT models the network entity being a first network entity and is used by a second network entity to derive a command for the first network entity as a stimulus to cause a targeted behaviour of the first network entity; the method comprising transmitting the command to the first network entity,
the DT models the network entity and is used by the network entity to derive a command for the network entity as a stimulus to cause a targeted behaviour of the network entity; the method comprising executing the command with the first network entity, or
when the network entity is a first entity, the stimulus is determined as a stimulating behaviour to be shown by a second network entity to act as a stimulus to the first network entity to cause the behaviour.

77. The method of claim 72, wherein the behaviour relates to a beam pattern formed with the wireless interface of a network node comprising the network entity.

78. The method of claim 72, wherein the network entity comprises at least one of a radio unit; a distributed unit; a centralized unit a BTS antenna; a UE antenna; an IAB antenna; and a reconfigurable intelligent surface, RIS.

79. The method of claim 72, wherein the network node comprises at least one of a basestation (BTS); eNB (4G-LTE); gNB (5G-NR); a user equipment (UE); a repeater; a network controller; a RIS controller; an access node; a backhaul node; an integrated access and backhaul (IAB) device; a terrestrial network; and a non-terrestrial network.

80. The method of claim 72, further comprising predicting, by the DT, the behaviour as a performance characteristics of the network entity.

81. The method of claim 72, further comprising:
generating the DT during at least one of manufacturing or calibration;
storing the DT in a memory accessible for one or more entities; and
accessing the DT with the one or more entities.

82. The method of claim 81, wherein the one or more entities comprise at least one of an authorised entity, a recognised entity and a requesting entity, and the DT is provided with a different granularity to entities having a different priority such that a priority is associated with a granularity.

83. The method of claim 72, wherein the DT includes a combined DT, and the method further comprises:
acquiring a first DT of a first component of the wireless communication network;
acquiring a second DT of a second component of the wireless communication network; and
combining the first DT and the second DT to acquire the combined DT.

84. The method of claim 72, further comprising exposing the DT in the wireless communication network.

85. The method of claim 72, further comprising:
modelling, by the DT, at least one of a diversity capability and a multiplexing capability of the network entity;
deriving capability information indicating the at least one of the diversity capability and deriving multiplexing information indicating the multiplexing capability; and
using at least one of the capability information and the multiplexing information for controlling communication with the network entity.

86. The method of claim 72, further comprising:
using the DT of the network entity to derive a stimulus to the network entity resulting in the targeted behaviour of the network entity;
wherein the stimulus is part of a set of stimuli that includes a plurality of stimuli originated in at least one entity, the set of stimuli causing the targeted behaviour; and
wherein the method further comprises deriving the set of stimuli; and generating the set of stimuli to cause the targeted behaviour.

87. The method of claim 72, wherein the DT is a first DT of the network entity being a first network entity forming at least a part of a first network node, the method further comprises:
using a second DT of a second network entity forming at least a part of a second network node communicating with the first network node through a radio propagation channel; and
determining a propagation of a radio signal along a first direction from the first network node to the second network node; and determining a propagation of a radio signal along a second direction from the second network node to the first network node using the first DT and the second DT.

88. The method of claim 87, further comprising:
observing a radio channel between the first network node and the second network node for at least one direction between the first network node and the second network node to acquire a radio channel information;
combining the radio channel information with the first DT and the second DT to determine the radio channel propagation; and
optimizing a beamforming of the first entity and/or the second entity for the radio channel.

89. The method of claim 72, further comprising at least one of:
using the DT for a localisation of the network entity and/or for a mapping of an environment of the network entity; and
using information indicating a relative orientation and information indicating an angle of arrival of an incoming radio signal and/or an angle of departure of an outgoing radio signal to adapt a beam pattern formed with a network node comprising the network entity.

90. A method comprising:
using a device by a user;
measuring a behaviour of the device during a first instance of time when the device is used by the user to acquire a measurement result;
using a digital twin (“DT”) of at least a part of the device and using the measurement result to generate a DT of the user; and
using the DT of the user for evaluating a behaviour of the device during a second, later instance of time.

91. The method of claim 90, further comprising:
using the DT of the user to identify or classify the user as a user using the device; and
generating a respective DT for a plurality of users; and identifying a user that uses the device based on the plurality of DTs of the plurality of users based on a measurement result of the behaviour.

92. An apparatus comprising:
a controller configured to:
use a device by a user;
measure a behaviour of the device during a first instance of time when the device is used by the user to acquire a measurement result;
use a digital twin (“DT”) of at least a part of the device and use the measurement result to generate a DT of the user; and
use the DT of the user for evaluating a behaviour of the device during a second, later instance of time.
